(19) United States
(12) Patent Application Publication
(10) Pub. No.: US 2008/0068672 A1
(43) Pub. Date: Mar. 20, 2008

(54) Image processing apparatus, information providing system, server apparatus, and program

(75) Inventors: Yasuhiro Nakai, Kyoto (JP); Syoichiro Yoshiura, Nara (JP)

Correspondence Address: EDWARDS ANGELL PALMER & DODGE LLP, P.O. BOX 55874, BOSTON, MA, 02205, US

(73) Assignee: Sharp Kabushiki Kaisha, Osaka (JP)

(21) Appl. No.: 11/900,826

(22) Filed: Sep. 13, 2007

(30) Foreign Application Priority Data
Sep. 14, 2006 (JP) 2006-249226
Sep. 14, 2006 (JP) 2006-249229

(51) Int. Cl. H04N 1/387

(52) U.S. Cl. 358/453

(57) ABSTRACT

An image processing apparatus that can provide image information such as advertisements and guides to people not limiting specific users. The image processing apparatus includes an image reading portion that optically reads an image of an original, an image information extracting portion that extracts image information from the image of the original read by the image reading portion, an image information selecting portion that selects image information to be provided related to the image information extracted by the image information extracting portion from a plurality of pieces of image information to be provided prepared in advance, and an image information output portion that outputs the image information selected by the image information selecting portion. The portion corresponding to the image information selecting portion is provided in a server apparatus connected to the image processing apparatus and information may be provided in the form that the information provider desires.

### CROSS-NOTING PARAGRAPH

This Nonprovisional application claims priority under 35 U.S.C. §119(a) on Patent Applications No. 2006-249226 filed in JAPAN on Sep. 14, 2006 and No. 2006-249229 filed in JAPAN on Sep. 14, 2006, the entire contents of which are hereby incorporated herein by references.

### FIELD OF THE INVENTION

The present invention relates to an image processing apparatus, an information providing system, a server apparatus, and a program, and, more specifically, to an image processing apparatus, an information providing system, a server apparatus, and a program to be incorporated therein, to provide information such as advertisements and guidance for users.

### BACKGROUND OF THE INVENTION

An apparatus or a system is present that is adapted to be able to read, from a card recorded with customer information such as a membership card, the information recorded therein using a dedicated card reader and provide information corresponding to the recorded information that has been read.

For example, Japanese Laid-Open Patent Publication No. 08-103549 discloses a customer managing system that is adapted to effectively facilitate improvement of the customer-attracting effect by providing customer services utilizing membership cards and prevent increase of the expense of an amusement facility associated with the work of issuing redemption tickets that is indispensable for the customer services.

In the system described in the above Japanese Laid-Open Patent Publication No. 08-103549, an input terminal reads an ID code with which a customer registered in advance can be identified from a membership card through a card reader. When it is judged that the membership card is valid, information on the customer services set in advance is displayed by a monitor. When an operation to receive one of the customer services displayed is executed, the input terminal issues using a printer a redemption ticket necessary for receiving the service and transmits data concerning the customer service to a POS terminal and a host computer.

Japanese Laid-Open Patent Publication No. 2004-157920 discloses a POS system that, in an environment where customer information can not be inquired about through real-time communication of a data center that collectively manages all pieces of the customer information, where each store can not retain all the pieces of information because of a large number of members, or where any device to read an external storing medium such as an IC card or a magnetic card can not be installed (hereinafter, “local environment”), sells items at preferential prices to specific people, outputs specific information to specific people when the people buy items, and grasps the correct ages of buyers to more accurately analyze the sales performance.

In the system described in the above Japanese Laid-Open Patent Publication No. 2004-157920: a membership card recorded with a member's number obtained by converting the sex and the date of birth of the member is used considering the security; a scanner reads the member's card having a bar code thereon that represents the sex and the date of birth that are encrypted as member information; the scanner reads an item code; and, when the member is to be preferentially treated based on the sex and the date of birth, and preferential treatment information of the item stored in a PLU (Price Look Up) master file, outputs the preferential treatment information stored in the PLU master file.

### SUMMARY OF THE INVENTION

The information of the services that can be provided by the system of the above Japanese Laid-Open Patent Publication No. 08-103549 is prepared in advance depending on the identifying information to identify the member to provide the services. Similarly, the information that can be provided by the system described in the above Japanese Laid-Open Patent Publication No. 2004-157920 is prepared in advance depending on the member information.

Therefore, in the systems described in the above Japanese Laid-Open Patent Publication No. 08-103549 and Japanese Laid-Open Patent Publication No. 2004-157920: the information can not be provided for any person other than the members; the information can not be provided for a wide range of people; the information that is provided for the members is also prepared in advance for the information service related to the organization; and information on the items and services not related to the member can not be provided.

An object of the present invention has been forged considering the above actual context and is to provide an image processing apparatus, an information providing system, a server apparatus, and a program to be incorporated therein, that can provide image information such as advertisements and guidance to people who are not limited to specific users.

In order to achieve the above object, a first technical means of the present invention is an image processing apparatus comprising: an image reading portion that optically reads an image of an original; an image information extracting portion that extracts image information from the image of the original read by the image reading portion; an image information selecting portion that selects image information to be provided related to the image information extracted by the image information extracting portion from a plurality of pieces of image information to be provided prepared in advance; and an image information output portion that outputs the image information to be provided selected by the image information selecting portion.

A second technical means is the image processing apparatus as defined in the first technical means, wherein the image information to be provided includes any of advertisement information of an item or a service related to the image information, application information of an item or a service related to the image information, procedure guiding information related to the image information, the latest information related to the image information, detailed information related to the image information, and appendix information related to the image information.

A third technical means is the image processing apparatus as defined in the first technical means, wherein the image information extracting portion executes extraction including any of extraction of a text, extraction of a color, and extraction of image features as the extraction of the image information.

A fourth technical means is the image processing apparatus as defined in the first technical means, wherein the image information extracting portion cuts out a portion of the image of the original read by the image reading portion and executes extraction of image information from the cut-out partial image.

A fifth technical means is the image processing apparatus as defined in the first technical means, wherein the image information selecting portion comprises: an information selecting portion that selects a plurality of pieces of image information to be provided related to the image information extracted by the image information extracting portion; an overview presenting portion that presents to a user overview information related to the selected plurality of pieces of image information to be provided; and an overview selecting portion that causes the user to select overview information of image information to be provided that the user desires to output from the presented plurality of pieces of overview information, wherein the image information selecting portion selects image information to be provided related to the selected overview information as information to be output by the image information output portion.

A sixth technical means is the image processing apparatus as defined in the first technical means, further comprising: an image processing portion that applies image processing to the image of the original read by the image reading portion; and an image output portion that outputs the information on the image of the original processed by the image processing portion.

A seventh technical means is the image processing apparatus as defined in the sixth technical means, wherein the image information selecting portion outputs the image of the original read by the image reading portion using the image processing portion and the image output portion when image information to be provided to be selected is not present.

An eighth technical means is the image processing apparatus as defined in the first technical means, wherein the image information selecting portion comprises a presenting portion that presents to the user whether image information to be provided to be selected is present.

A ninth technical means is the image processing apparatus as defined in the first technical means, wherein the image information output portion outputs the image information selected by the image information selecting portion by any process of a printing process, a displaying process, a file-storing process, and a file-transmission process.

A tenth technical means is the image processing apparatus as defined in the first technical means, wherein the image information output portion comprises: a printing portion that outputs by a printing process the image information selected by the image information selecting portion; and a setting portion that causes a user to set printing conditions for printing by the printing portion.

An eleventh technical means is the image processing apparatus as defined in the first technical means, wherein the image processing apparatus is a multi-function peripheral having at least a printing function and a copying function.

A twelfth technical means is the image processing apparatus as defined in the first technical means, further comprising a designating portion that designates the correlation between the image information and the image information to be provided in the image information selecting portion.

A thirteenth technical means is the image processing apparatus as defined in the first technical means, further comprising a storing portion that stores a plurality of pieces of image information to be provided to be selected by the image information selecting portion.

A fourteenth technical means is an information providing system comprising the image processing apparatus as defined in the first technical means and a server apparatus, wherein the server apparatus comprises: a storing portion that stores the plurality of pieces of image information to be provided to be selected by the image information selecting portion; and a retrieving portion that returns a selection result based on a selection request from the image information selecting portion.

A fifteenth technical means is the information providing system as defined in the fourteenth technical means, wherein the server apparatus comprises a designating portion that designates the correlation between the image information and the image information to be provided in the image information selecting portion.

A sixteenth technical means is a server apparatus that can be connected to an image processing apparatus comprising an image reading portion that optically reads an image of an original, comprising: an image information extracting portion that receives an image of an original read by the image reading portion and extracts image information from the image of the original; and an image information selecting portion that selects image information to be provided related to the image information extracted by the image information extracting portion from plural pieces of image information to be provided prepared in advance and that transmits the selected information to the image processing apparatus, wherein the image processing apparatus comprises an image information output portion that outputs the image information to be provided selected by the image information selecting portion.

A seventeenth technical means is a program incorporated into the image processing apparatus as defined in the first technical means, wherein a control portion of the image processing apparatus is caused to function as the image information extracting portion and the image information selecting portion.

An eighteenth technical means is a program incorporated into the server apparatus in the information providing system as defined in the fourteenth technical means, wherein a computer is caused to function as the server apparatus.

A nineteenth technical means is a program incorporated into the server apparatus as defined in the sixteenth technical means, wherein a computer is caused to function as the server apparatus.

Furthermore, in the systems described in the above Japanese Laid-Open Patent Publication No. 08-103549 and Japanese Laid-Open Patent Publication No. 2004-157920, a user operating screen for providing the information has no multi-purpose characteristic. Therefore, even when a third party tries to provide the information on either of the systems, it is difficult for the third party to directly produce as he/she desires information that he/she desires to provide and he/she has no choice but to rely on the business entity that operates the system.

Another object of the present invention has been forged considering the above actual context and is to provide an information providing system, a server apparatus, and a program to be incorporated therein, that can provide image information such as advertisements and guidance to people who are not limited to specific users and that can easily provide the information in the form that the providing source of the image information desires.

In order to achieve the another object, a twentieth technical means of the present invention is an information providing system that provides image information to be provided to a user using an image processing apparatus, comprising: an image processing apparatus comprising: the image reading portion that optically reads an image of an original; and a displaying portion that displays a user operation screen; and a server apparatus connected to the image processing apparatus through a network, comprising: a storing portion that stores a plurality of pieces of image information to be provided and user operation screen information for the image processing apparatus, wherein the system further comprises: an image information extracting portion that extracts image information from the image of the original read by the image reading portion; and an image information selecting portion that selects image information to be provided related to the image information extracted by the image information extracting portion from the plurality of pieces of image information to be provided stored in advance by the storing portion, wherein the image processing apparatus comprises an image information output portion that outputs the image information to be provided selected by the image information selecting portion, and wherein the image processing apparatus receives the user operation screen information transmitted from the server apparatus and displays the received information using the displaying portion.

A twenty-first technical means is the information providing system as defined in the twentieth technical means, wherein the image processing apparatus receives the user operation screen information transmitted from the server apparatus and displays the image information to be provided incorporating into the received user operation screen information using the displaying portion.

A twenty-second technical means is the information providing system as defined in the twentieth technical means, wherein the server apparatus selects the user operation screen information to be transmitted to the image processing apparatus based on the image information extracted by the image information extracting portion or based on the image information to be provided selected by the image information selecting portion.

A twenty-third technical means is the information providing system as defined in the twentieth technical means, wherein the image information selecting portion is provided in the server apparatus.

A twenty-fourth technical means is the information providing system as defined in the twentieth technical means, wherein the image information extracting portion is provided in the image processing apparatus.

A twenty-fifth technical means is the information providing system as defined in the twentieth technical means, wherein the image information extracting portion is provided in the server apparatus.

A twenty-sixth technical means is the information providing system as defined in the twentieth technical means, wherein the image information selecting portion comprises: an information selecting portion that selects a plurality of pieces of image information to be provided related to the image information extracted by the image information extracting portion; an overview presenting portion that presents to a user overview information related to the selected plurality of pieces of image information to be provided; and an overview selecting portion that causes the user to select overview information of image information to be provided that the user desires to output from the presented plurality of pieces of overview information, wherein the image information selecting portion selects image information to be provided related to the selected overview information as information to be output by the image information output portion, and wherein the overview information is displayed being incorporated into the user operation screen information by the displaying portion.

A twenty-seventh technical means is the information providing system as defined in the twentieth technical means, wherein the image information selecting portion comprises a presenting portion that presents to the user whether image information to be provided to be selected is present, wherein the presence or absence is displayed being incorporated into the user operation screen information by the displaying portion.

A twenty-eighth technical means is the information providing system as defined in the twentieth technical means, wherein the image information selecting portion comprises a charging information presenting portion that presents to a user charging information for the image information to be provided to be selected, wherein the charging information is displayed being incorporated into the user operation screen information by the displaying portion.

A twenty-ninth technical means is the information providing system as defined in the twentieth technical means, wherein the image information to be provided to be selected by the image information selecting portion is added with securing information that secures the output form thereof.

A thirtieth technical means is the information providing system as defined in the twentieth technical means, wherein the server apparatus comprises a totaling portion that totals the image information to be provided selected by the image information selecting portion and output by the image information output portion.

A thirty-first technical means is the information providing system as defined in the twentieth technical means, wherein the image information to be provided includes any of advertisement information of an item or a service related to the image information, application information of an item or a service related to the image information, procedure guiding information related to the image information, the latest information related to the image information, detailed information related to the image information, and appendix information related to the image information.

A thirty-second technical means is the information providing system as defined in the twentieth technical means, wherein the image information extracting portion executes extraction including any of extraction of a text, extraction of a color, and extraction of image features as the extraction of the image information.

A thirty-third technical means is the information providing system as defined in the twentieth technical means, wherein the image processing apparatus is a multi-function peripheral having at least a printing function and a copying function.

A thirty-fourth technical means is a server apparatus in the information providing system as defined in the twentieth technical means.

A thirty-fifth technical means is a program incorporated into the server apparatus in the information providing system as defined in the twentieth technical means, wherein the program causes a computer to function as the server apparatus.

### BRIEF DESCRIPTION OF THE DRAWINGS

FIG. 1 is a diagram for describing an exemplary operation of an information providing service using an information providing system according to the present invention;

FIG. 2 is a block diagram of exemplary configurations respectively of a digital multi-function peripheral and a server in the system of FIG. 1;

FIG. 3 is a block diagram for describing an exemplary internal configuration of the digital multi-function peripheral in the system of FIG. 1;

FIG. 4 is a top plan view of the appearance of a scanner portion in the digital multi-function peripheral of FIG. 3;

FIG. 5 is a diagram of an exemplary configuration of a user I/F portion in the digital multi-function peripheral of FIG. 3;

FIGS. 6A, 6B, and 6C are diagrams respectively of examples of a license to be scanned in the digital multi-function peripheral of FIG. 3;

FIGS. 7A, 7B, and 7C are diagrams respectively of examples of an overview information list displayed on a displaying portion when the licenses of FIGS. 6A, 6B, and 6C are respectively scanned;

FIGS. 8A and 8B are diagrams of an example of image information to be provided displayed on the displaying portion when a peripheral area driving guide is selected by a user from the overview information list of FIGS. 7A, 7B, and 7C;

FIG. 9 is a flowchart for describing the exemplary processing shown in FIGS. 6A to 8B;

FIG. 10A is a diagram of an example of a student ID card to be scanned in the digital multi-function peripheral of FIG. 3;

FIG. 10B is a diagram of an example of image information to be provided displayed on the displaying portion when the student ID card of FIG. 10A is scanned;

FIG. 11 is a diagram of an example of a credit card associated with an electric home appliance store to be scanned in the digital multi-function peripheral of FIG. 3;

FIG. 12A is a diagram of an example of an overview information list displayed on the displaying portion when the credit card associated with the electric home appliance store of FIG. 11 is scanned;

FIGS. 12B and 12C are diagrams of examples of image information to be provided displayed on the displaying portion when information on bargains of the day is selected by the user from the list of FIG. 12A;

FIG. 13A is a diagram of an example of a travel pamphlet to be scanned in the digital multi-function peripheral of FIG. 3;

FIG. 13B is a diagram of an example of an overview information list displayed on the displaying portion when the travel pamphlet of FIG. 13A is scanned;

FIG. 13C is a diagram of an example of image information to be provided displayed on the displaying portion when the latest information is selected by the user from the list of FIG. 13B;

FIG. 14 is a block diagram of other exemplary configurations of the digital multi-function peripheral and the server in the system of FIG. 1;

FIG. 15 is a block diagram for describing another exemplary internal configuration of the digital multi-function peripheral in the system of FIG. 1;

FIG. 16 is a diagram of an example of a magazine to be scanned in the digital multi-function peripheral of FIG. 15;

FIG. 17 is a diagram of an example of an overview information list displayed on the displaying portion when the magazine of FIG. 16 is scanned;

FIG. 18 is a diagram of an example of charging information displayed on the displaying portion when a comic book “A” is selected by the user from the overview information list of FIG. 17;

FIG. 19 is a flowchart for describing exemplary processing shown in FIGS. 16 to 18;

FIG. 20 is a diagram of an example of a travel pamphlet to be scanned in the digital multi-function peripheral of FIG. 15; and

FIG. 21 is a diagram of an example of an overview information list displayed on the displaying portion when the travel pamphlet of FIG. 20 is scanned.

### PREFERRED EMBODIMENT OF THE INVENTION

### First Embodiment

An image processing apparatus according to an embodiment of the present invention is an apparatus that provides, from cards, catalogs and magazines of items or services, wrapping paper sheets (packaging boxes), etc., which are brought by a user, image information (image information to be provided) such as advertisements, guidance, etc., related to the above to the user. Though the above information provision can be realized in an image processing apparatus alone, it is more preferable to implement the above information provision as an information providing system connected to a server apparatus that stores the image information to be provided, considering the limitation on memories of the image processing apparatus and the load of the recording process (including an updating process) of the image information to be provided on each image processing apparatus.

Description will be given for the embodiment taking an example of the information providing system including the image processing apparatus and the server apparatus and for the difference between the above case and the case where an information providing function according to the present invention is realized by the image processing apparatus alone as appropriate. Various apparatuses such as a multi-function peripheral having various functions including a copying function and a printing function, and a multi-purpose computer connected to a scanner apparatus in addition to an image forming apparatus including a copying machine can be applied as the image processing apparatus according to the present embodiment, and a digital multi-function peripheral will be exemplified.

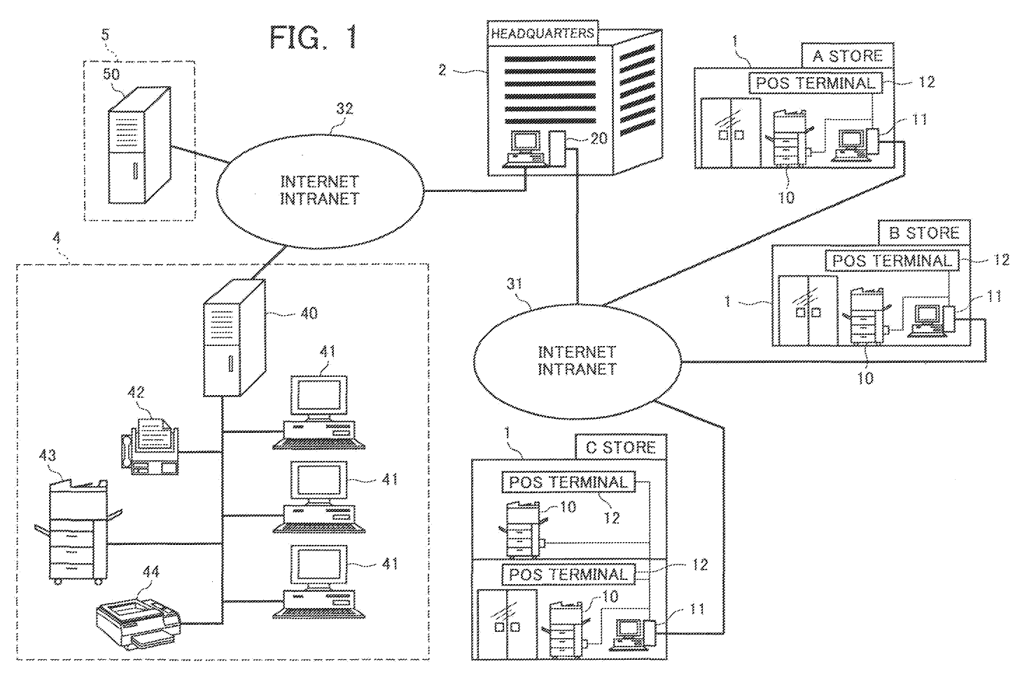

FIG. 1 is a diagram for describing an exemplary operation of the information providing service using the information providing system according to the present invention. FIG. 1 shows an exemplary configuration of a network system to provide image information to be provided that a server apparatus (hereinafter, “server”) 20 retains, to a digital multi-function peripheral 10 connected through a communication line. That is, in this example, the information is provided by the digital multi-function peripheral 10 and the server 20 cooperating with each other.

The information providing service is operated by the headquarters 2 of chain stores 1 such as “A Store”, “B Store”, and “C Store”. For example, convenience stores can be listed as the chain stores 1. The server 20 is installed in the headquarters 2 to operate the information providing service. At least the digital multi-function peripheral 10 and also a PC (PC terminal) 11 are installed in each of the chain stores 1. The PC terminal 11 functions as a server in the chain stores 1, is connected to the digital multi-function peripheral 10, and is also connected to a POS terminal 12, etc. The server 20 is connected to the PC terminal 11 of each of the chain stores 1 through the Internet/intranet 31 or is directly connected to the digital multi-function peripheral 10.

For example, the server 20 is further connected to servers 40 and 50 respectively installed by providing sources 4 and 5 of the image information to be provided, through the Internet/intranet 32. As to these servers 40 and 50, the server 40 is connected to a network system configured by an in-house LAN as shown. This network system is connected to, for example, a plurality of PCs 41, a FAX 42, a digital multi-function peripheral 43, a printer 44, etc. The number of providing sources and the configuration of the network system installed thereto are not limited to the above. The providing sources may directly transmit the image information to be provided to the headquarters 2 using a recording medium. Otherwise, the headquarters 2 may create the image information to be provided in response to a request from the providing sources.

In the above exemplary configuration, the information provision according to the present embodiment is enabled by the network system of the in-house LAN and the digital multi-function peripheral 10 installed in each of the chain stores 1. When A Store, B Store, and C Store are not in the same chain, when those stores include store(s) that is(are) not in the same chain, or when those stores are installation places other than stores (such as stores in stations, or public facilities including libraries and government offices), the headquarters 2 corresponds to a manufacturer that sells the digital multi-function peripheral 10 or a sales company thereof, etc.

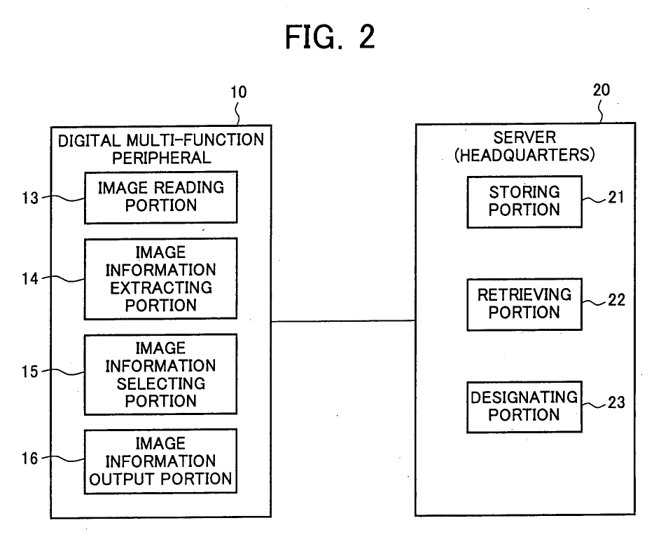

FIG. 2 is a block diagram of exemplary configurations respectively of the digital multi-function peripheral and the server in the system of FIG. 1. To enable the information provision according to the present embodiment, the digital multi-function peripheral 10 includes an image reading portion 13, an image information extracting portion 14, an image information selecting portion 15, and an image information output portion 16 that will be described as follows. The server 20 includes a storing portion 21, a retrieving portion 22, and a designating portion 23.

The image reading portion 13 corresponds to an apparatus such as a scanner that optically reads an image of an original and is a portion ordinarily provided in the digital multi-function peripheral 10.

In this case, typical objects to be read (to be scanned) can be, for example, membership cards (rental, club), point cards, bank cards, credit cards, company-employee ID cards, student ID cards, insurance cards, licenses, item catalogs (electric home appliances, cars, etc.), service catalogs (substituting services, cleaning services, etc.), pamphlets (travels, etc.), cover pages and back cover pages of books (periodically sold magazines including weekly magazines, consecutively sold books including comic books), and outer cases of sweets and toys. As exemplified with a bank card and a credit card, a card medium such as a magnetic-recording-type card or an IC card that records and retains identifying information such as information on members, and from which the identifying information is read using a dedicated reader such as a card reader can be applied to a card. However, the information provision according to the present embodiment is executed by at least optically reading information on the front face or the back face of each of those card media.

The image information extracting portion 14 extracts image information from the image of the original read by the image reading portion 13. In this case, the image information extracting portion 14 preferably executes the extraction of the image information including any of extraction of texts (text information), extraction of color (color information, color tone information), and extraction of image features. The extraction of the image features means extraction of shape information having features (shape feature information) such as a logo.

The image information selecting portion 15 selects image information to be provided related to the image information extracted by the image information extracting portion 14, from a plurality of pieces of image information to be provided prepared in advance. The extracted image information surely differs from the image information to be provided that is to be selected, and new image information (image information to be provided) is selected based on the image information. The image information extracting portion 14 and the image information selecting portion 15 (and the designating portion described later) in the digital multi-function peripheral 10 may be incorporated as a program and a control portion of the digital multi-function peripheral 10 may be caused to function as those portions. The present invention can employ the form of the program to be incorporated in the image processing apparatus such as this digital multi-function peripheral 10. The above program can be distributed through a network or being stored in recording media.

The storing portion 21 of the server 20 stores the plural pieces of image information to be provided that are to be selected by the image information selecting portion 15. The pieces of image information to be provided may be updated through a network or may directly updated by reading from a portable recording medium. The retrieving portion 22 returns the selection result based on a selection request from the image information selecting portion 15. The designating portion 23 designates the correlation between the image information and the image information to be provided in the image information selecting portion 15. Though the designating portion 23 may not be provided, the correlation at least needs to be executed in advance.

The server 20 can be configured by a computer (that is, a server computer) and a storing apparatus thereof corresponds to the storing portion 21. The retrieving portion 22 and the designating portion 23 are configured by being executably stored in a rewritable ROM, an HDD, etc., as a server program. The server program is read and brought into a volatile memory such as an incorporated RAM that is a working area, and is executed by a calculation processing apparatus such as a CPU incorporated in the server computer. The present invention can take the form of this server program. This server program may be distributed through a network or being stored in a recording medium.

The image information output portion 16 can also be referred to as “image information providing portion” and provides image information to users by outputting the image information selected by the image information selecting portion 15. In this case, the image information output portion 16 may output using any one or more process (es) of a printing process, a displaying process, a file storing process, and a file transmitting process to the image information selected by the image information selecting portion 15.

In this case, examples of a combination of [item to be scanned: image information to be provided] can include [membership card: the latest information and campaign information], [point card: campaign information, item information, point information], [bank card: pamphlets of and application forms for services including a loan], [credit card: campaign information], [company employee ID card and student ID card: information on discount for employees], [insurance card, license: information on procedure guidance], [item catalog: the latest information and detailed information], [service catalog: the latest information and detailed information], [pamphlet: the latest information, detailed information, and additional information], [book: the latest issue], and [outer boxes of sweets and toys: information on giveaways and information on appendix (including the appendix itself)]. In addition, for all these items to be scanned, information on various items and services can be provided. However, many merits can be obtained when the information to be provided is suitable for the item to be scanned is selected. Therefore, the information to be provided is selected by the image information selecting portion 15. As to the image information to be selected and provided, detailed examples will be given later.

As above, the image information to be provided preferably includes any one of advertisement information of items or services related to the image information, application information of items or services related to the image information, procedure guiding information related to the image information, the latest information related to the image information, detailed information related to the image information, and appendix information related to the image information.

The digital multi-function peripheral 10 preferably includes the image processing portion and the image output portion though those portions are normally equipped and, in the following example, are referred to as the printing portion. This image processing portion applies image processing to the image itself of the original that is read by the image reading portion 13. The image output portion outputs information on the image of the original processed by the image processing portion. The image information output portion deals with objects to be output that are only different from those of the image output portion, and these portions can also be said to be portions that are the image processing portion that applies various types of image processing and the image output portion that outputs thereafter.

As another configuration, the image information extracting portion 14 and the image information selecting portion 15 may be provided to the server 20. These portions 14 and 15 may also be implemented as a server program. In this configuration, the image information extracting portion 14 in the server 20 receives the image of the original read by the image reading portion 13 of the digital multi-function peripheral 10, and extracts the image information from the image of the original. The image information selecting portion 15 selects image information to be provided related to the image information extracted by the image information extracting portion 14 from the plurality of pieces of image information to be provided prepared in advance by storing those pieces of image information in the storing portion 21, and transmits the selected image information to the digital multi-function peripheral 10. Having received the transmitted image information, the digital multi-function peripheral 10 outputs the selected and transmitted image information using the image information output portion 16. Therefore, in this configuration, the digital multi-function peripheral 10 may only include the image reading portion 13 and the image information output portion 16.

According to yet another configuration, when the digital multi-function peripheral 10 alone realizes the information provision according to the present embodiment, the storing portion 21 is provided in the digital multi-function peripheral 10 and the storing portion in the digital multi-function peripheral 10 only have to store the image information to be provided to be selected. The image information to be provided only has to be updated through a network or by directly reading the information from a portable recording medium as necessary. The designating portion 23 only has to be provided in the digital multi-function peripheral 10. In this configuration, the image information selecting portion 15 selects the image information to be provided related to the image information extracted by the image information extracting portion 14 from the plural pieces of image information to be provided prepared in advance in the internal storing portion.

As above, in the present embodiment, based on the image data obtained by reading not only a membership card brought by a user but also various items as an image of the original, image information to be provided to the user is selected and output. That is, in the present embodiment, when predetermined image information such as features of the original from the original image is confirmed by extraction, new image information to be provided can also be selected and output to be provided based on the extracted image information. When plural pieces of extracted image information are present, plural pieces of image information to be provided based respectively on those pieces of extracted image information can also be provided.

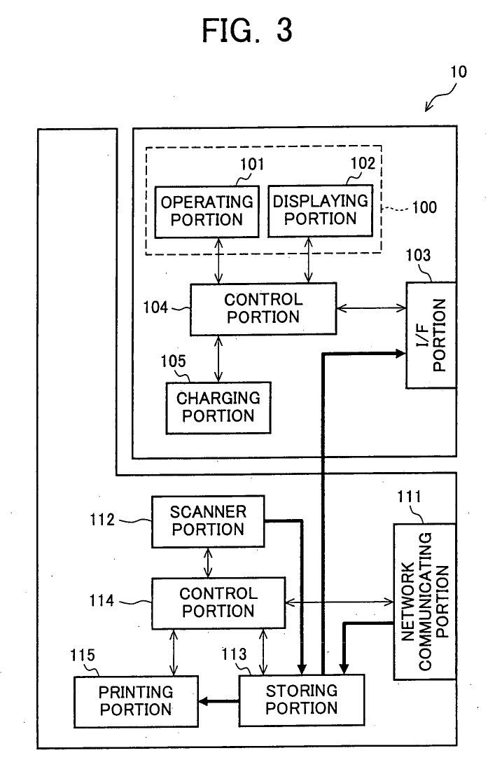

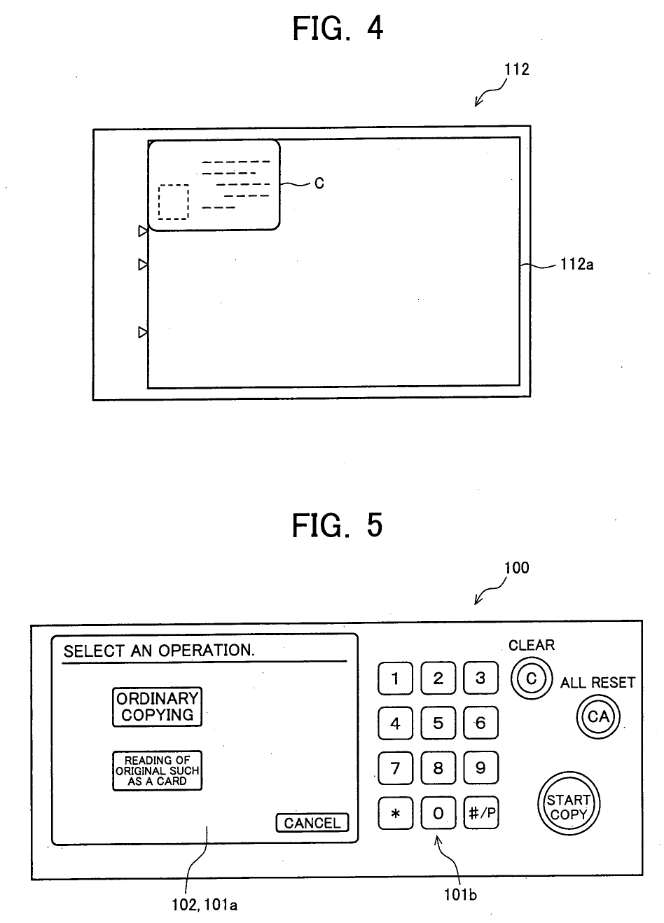

FIG. 3 is a block diagram for describing an exemplary internal configuration of the digital multi-function peripheral in the system of FIG. 1. FIG. 4 is a top plan view of the appearance of a scanner portion in the digital multi-function peripheral of FIG. 3. FIG. 5 is a diagram of an exemplary configuration of a user I/F portion in the digital multi-function peripheral of FIG. 3. Referring to FIGS. 3 to 5 together, description will be given for the digital multi-function peripheral 10 (and the server 20) of FIG. 2 taking a detailed exemplary configuration thereof.

The digital multi-function peripheral 10 includes a user I/F portion 100 configured by an operating portion 101 and a displaying portion 102. The operating portion 101 consists of a hard key group 101b such as ten keys and buttons to make various settings, a touch panel 101a, etc., and enables input operations by a user. The displaying portion 102 consists of a liquid crystal panel that displays various information screens, etc., and may be configured to be included by the above touch panel. The displaying portion 102 is also configured to output the image information to be provided to the user by a displaying process. Therefore, the displaying portion 102 can be caused to function as one of the above image information output portion and the image output portion, together with the control portions 104 and 114 that select the information to be output and instruct to display the information.

The digital multi-function peripheral 10 includes an I/F portion 103 to read and write data from/to a recording medium such as a USB memory. The I/F portion 103 is configured to output data such as image information to a recording medium to execute a file-storing process, and can be caused to function as one of the above image information output portion and the image output portion, together with the control portions 104 and 114 that select the information to be output and instruct to display the information.

The charging portion 105 collects fees such as copying fee from the user. The charging portion 105 is adapted to be able to execute any one of charging procedure of various charging procedures such as the settlement by a non-contact IC card, etc., and the settlement by putting in coins.

The control portion 104 controls the user I/F portion 100, the I/F portion 103, and the charging portion 105. The control portion 104 incorporates or is connected to, for example, a non-volatile memory such as a ROM that stores a control program, etc., to control these portions. The control program is read and brought into a volatile memory such as an incorporated RAM that is a working area, and is executed by a calculation processing apparatus such as a CPU incorporated in the control portion 104. The control portion 104 controls the entire digital multi-function peripheral 10 together with the control portion 114 described later with either of the control portions 104 and 114 being the main control portion. Description will be given for a case where the control portion 114 is the main control portion and the control portion 104 is the sub control portion.

The network communicating portion 111 constitutes an I/F with a predetermined communication network such as a public line network or a LAN. The data obtained from the communication network by the network communicating portion 111 is retained in a storing portion 113 or a temporary memory. The storing portion 113 is a storing apparatus such as an HDD or a rewritable ROM. The network communicating portion 111, and together with the storing portion 113 especially for the in house use, together with the control portions 104 and 114 that select information to be output and issue instructions such as file transmission and file storage including mail transmission, can be caused to function as one of the above image information output portion and the image output portion.

As exemplified in FIG. 4, the scanner portion 112 obtains an image of an original (image data of the original) by reading the image of the original for the original such as a card C that the user has mounted on an original glass 112a and causes the storing portion 113 or a temporary memory to store the image. In this case, the start of the scanning, etc., is executed by the user I/F portion 100. As exemplified in FIG. 5, the touch panel 101a may be incorporated with a graphical user I/F (GUI) to enable an operation to execute “ordinary copying” and an operation to request provision of the image information to be provided by executing “reading an original such as a card”. By causing the GUI to display the image only for the latter, the operation only for copying may be simplified.

The printing portion 115 reads the original image data that the scanner portion 112 has read, printing data externally input through the network communicating portion 111, etc., from the storing portion 113 or the temporary memory, and outputs those data by printing-processing on sheets such as paper sheets. The printing portion 115 can be caused to function as one of the above image information output portion and the image output portion, together with the control portions 104 and 114 that select the data to be output and instruct to print the data.

The control portion 114 controls the network communicating portion 111, the scanner portion 112, the storing portion 113, the printing portion 115, and the control portion 104. The control portion 114 incorporates or is connected to, for example, a non-volatile memory such as a ROM that stores a control program, etc., to control these portions. The control program is read into a volatile memory such as an incorporated RAM that is a working area, and is executed by a calculation processing apparatus such as a CPU incorporated in the control portion 114.

As above, the control program incorporated in the control portion 114 is a program to cause the control portion 114 (an internal calculation processing apparatus) of the digital multi-function peripheral 10 to function as the image information extracting portion 14 and the image information selecting portion 15. Depending on the configuration, this program includes a program to cause the control portion 114 to function as a designating portion that corresponds to the designating portion 23.

By executing this program, the control portion 114 controls such that the image information is extracted from the original image read by the scanner portion 112, image information to be provided related to the image information is selected by accessing the server 20, and the information is output by the printing portion 115, etc. The information for extraction (information indicating what information is to be extracted or information for pattern matching, etc.) may be stored in the storing portion 113 or the ROM, or be included in the program as a parameter.

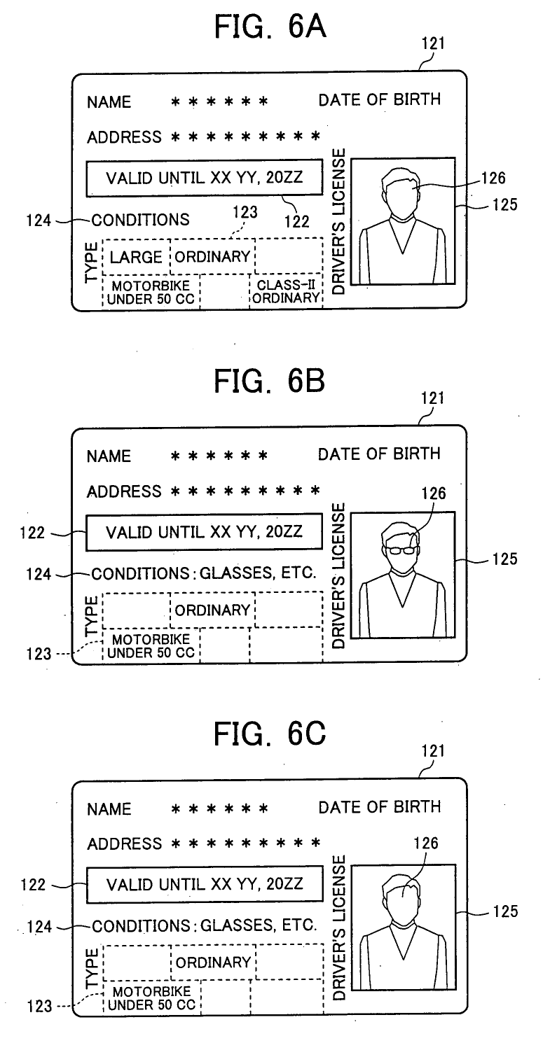

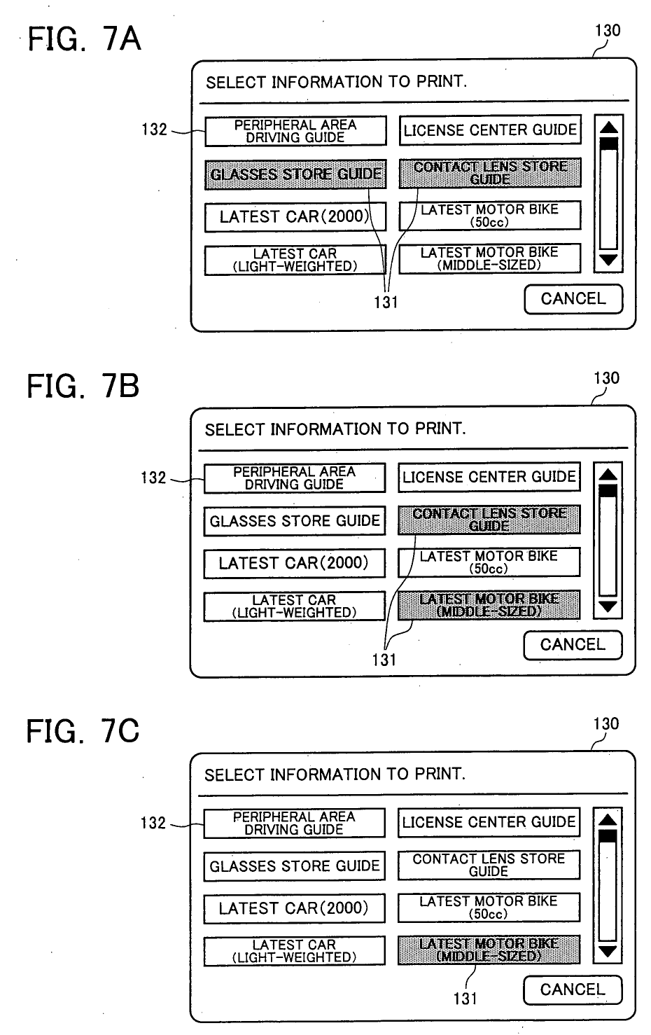

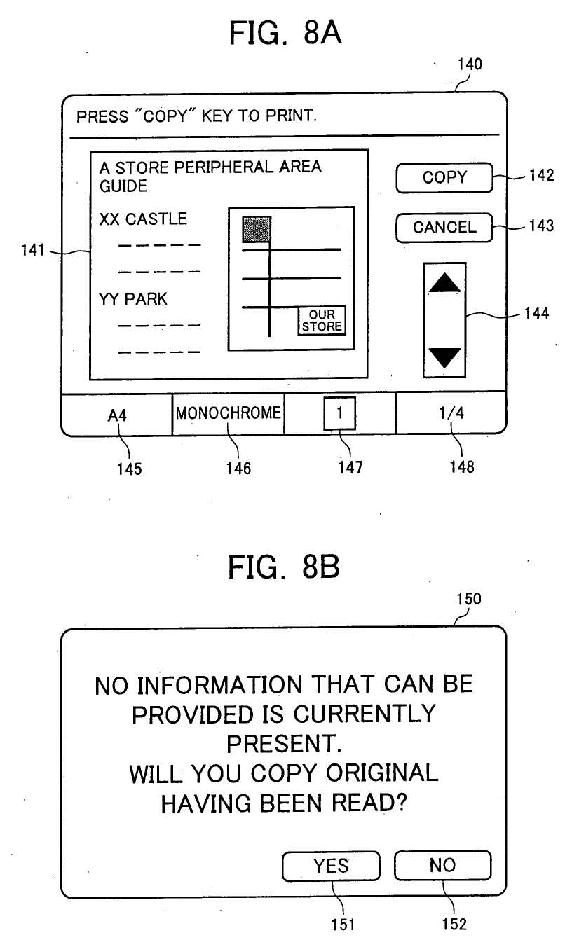

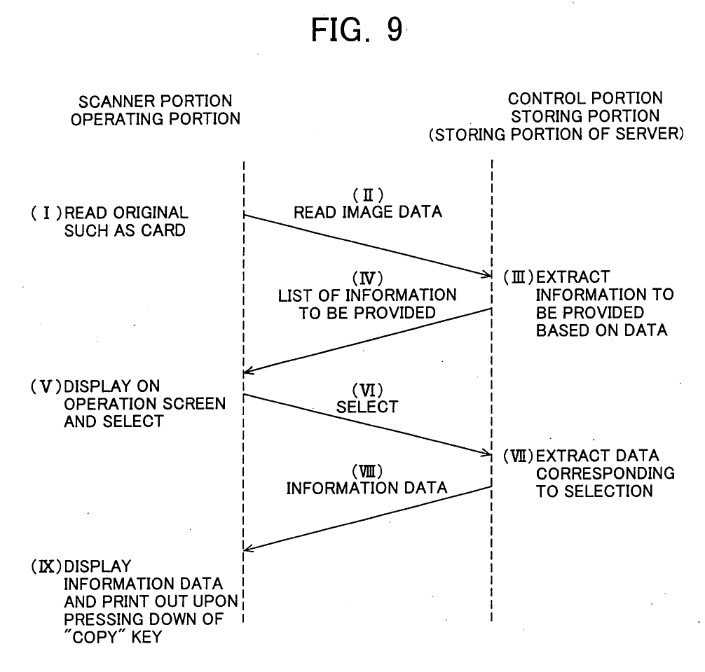

FIGS. 6A, 6B, and 6C are diagrams respectively of examples of a license to be scanned in the digital multi-function peripheral of FIG. 3. FIGS. 7A, 7B, and 7C are diagrams respectively of examples of an overview information list displayed on the displaying portion when the licenses of FIGS. 6A, 6B, and 6C are respectively scanned. FIGS. 8A and 8B are diagrams of an example of image information to be provided displayed on the displaying portion when a peripheral area driving guide is selected by a user from the overview information list of FIGS. 7A, 7B, and 7C. FIG. 9 is a flowchart for describing the exemplary processing shown in FIGS. 6A to 8B.

Description will be given along the flow exemplified in FIG. 9. However, in the following description, the flow is not limited as follows, including, for example, that interaction with the server 20 is stopped when the image information to be provided is stored in the storing portion 113, and that the extracted image information is transmitted to the server 20 when the digital multi-function peripheral 10 executes processes to the extraction of the image information.

A user selects “reading original such as a card” in the touch panel 101a of FIG. 5 and the control portion 114 recognizes this selection. When a license 121 exemplified in FIG. 6A is mounted on the original glass 112a as the card C of FIG. 4 and is scanned by the scanner portion 112 (I), the read image data is transmitted to the control portion 114 (II). The control portion 114 controls to cause the network communicating portion 111 to access the server 20 through the intranet 31, and transmits the image data to the server 20.

In the server 20, the retrieving portion 22 extracts the image information from the image data and retrieves the image information to be provided stored in the storing portion 21 based on the extracted image information (III). The description has been given that the retrieving portion 22 does not execute the extraction of the image information in the example of FIG. 2. However, the extraction is executed in this case. The typical image information can be a face photograph 125 by extracting the features, an expiration date 122 by extracting a text, a type 123, or a condition 124. The text extraction may be executed by text retrieving after an OCR process.

The server 20 returns to the digital multi-function peripheral 10 data listing the overview information on the image information to be provided selected (extracted) as the retrieval result (IV). In the digital multi-function peripheral 10, the control portion 114 receives the listing data through the network communicating portion 111 and controls to cause the control portion 104 to display the listing in an operating screen (the touch panel 101a) of the displaying portion 102. As a result, the listing is displayed on the touch panel 101a (V).

In the above III and IV, for the license 121 of FIG. 6A, the control portion 114 selects a peripheral area driving guide 132, a license center guide, the latest car (in the 2,000 cc-class), the latest motorbike (50 cc), the latest car (in the light-weight class), and the latest motorbike (middle-sized), and the overview information of these items is displayed in the screen 130 exemplified in FIG. 7A on the displaying portion 102.

As above, the image information selecting portion 15 preferably has an information selecting portion that selects plural pieces of image information to be provided related to the image information extracted by the image information extracting portion 14, and an overview presenting portion that presents to the user the overview information related to the plural pieces of image information to be provided selected by the information selecting portion. That is, it is preferable that the image information to be provided that has once been selected by the image information selecting portion 15 is shown to the user and transmission of the piece of image information to be provided that is desired to be output of the shown image is displayed. Typical overview information can be information excerpted from the image information to be provided or a summary (thumbnail) of the image information.

The condition 124 as the image information does not include any indication of “glasses, etc.” and “glasses” are not present in the portion 126 of the face in the photograph 125 as the image information. Therefore, the extraction may be executed using the condition 124 and the portion 126 of the face as the image information such that the retrieving portion 22 dose not retrieve the overview information such as a glasses store guide and a contact lens store guide. As above, the image information extracting portion 14 may cut out a portion (in this case, the photograph 125) of the original image read by the image reading portion 13 and may extract the image information from the cut-out partial image.

The overview information such as the glasses store guide and the contact lens store guide may be adapted not to be selected substantially as the image information to be provided. For example, the overview information that has been extracted using the license as the image information, that has been retrieved, and that has been displayed in the list, but that has not been able to be extracted in the extraction executed using the condition 124 and the portion 126 of the face, may be displayed being blacked out (The user selection described later of this information may also be disabled.) as exemplified as the overview information 131 of the glasses store guide and the contact lens store guide of FIG. 7A. The license 121 includes the expiration date 122 described thereon and, in the case where the expiration date 122 is extracted as the image information, the license center guide may be displayed only when it is close to the expiration date.

At this point, because it can be extracted that the image information is a license and it is known that the user has the license, it is beneficial for both of the information providing source and the user to select the peripheral area driving guide, the license center guide, the latest car (in the 2,000 cc-class), the latest motorbike (50 cc), and the latest car (in the light-weight class), as the image information to be provided. The license 121 of FIG. 6A has “ordinary motorbike” as the type 123 therefor and the “ordinary motorbike” can be extracted as the image information. Therefore, it is beneficial to also select “the latest motorbike (middle-sized) as the image information to be provided. The designating portion 23 may designate the correlation to enable this selection.

The image information selecting portion 15 preferably includes an overview selecting portion that causes the user to select the overview information of the image information to be provided that the user desires to output from a plurality of pieces of overview information presented by the overview presenting portion. Therefore, the overview information is displayed being selectable by the user when displaying the list in the process at the above step V.

When selection is executed by the user, information indicating that the selection has been executed is transmitted from the operating portion 101 to the control portion 114 through the control portion 104 (VI). Describing an example where the peripheral area driving guide is selected in this case, it is known that the image information to be provided for which the overview information is “peripheral area driving guide” is desired to be output. Therefore, the control portion 114 controls to access again the server 20 through the network communicating portion 111 and requests to transmit the image information to be provided. The retrieving portion 22 of the server 20 retrieves the image information to be provided or calls again the retrieval result (VII). The server 20 using the communicating portion thereof transmits the image information to be provided (information data) to the digital multi-function peripheral 10 (VIII).

Having received the information data through the network communicating portion 111, the control portion 114 instructs the control portion 104 to cause the displaying portion 102 to display the image information to be provided (in this case, the peripheral area driving guide) (IX). The services that can be provided preferably are displayed in a list from the image information obtained by scanning as above, an instruction is preferably asked of the user about the content of the future processing, and the image information selecting portion 15 preferably selects finally the image information to be provided related to the overview information selected by the user as the information to be output by the image information output portion 16.

At the above IX, as a screen 140 of FIG. 8A, output by display including an “A Store peripheral area guide” image 141 is first executed, thereafter, only when the user presses down a copy key 142, the control portion 114 instructs the printing portion 115 to execute a printing process that is a further output, and the printing is executed. In addition to the copy key, the screen 140 displays a cancellation key 143 for canceling the printing, a scrolling key 144 for the A Store peripheral area guide image 141, a size 145 for printing, a monochrome/color setting key 146, and a key for aggregated processing (n in one or N-up) and the page number thereof 148.

The user can set the size 145 for printing, the monochrome/color setting key 146, and the key for aggregated processing (n in one or N-up) and FIG. 8A shows an example where A4, monochrome, and ordinary printing are selected respectively for the above items. In a configuration where the image information output portion 16 has a printing portion such as the printing portion 115 as above, the image information output portion 16 preferably has a setting portion that causes the user to set the printing conditions for printing by the printing portion. Thereby, the printing is enabled under the output conditions designated by the user.

This printing is based on monochrome printing and, when color printing is set, the printing may be charged and charging by the charging portion 105 may be executed. Especially, color printing is preferable for the case where a map is printed as the image information to be provided, etc., and the user strongly desires this color printing. Therefore, no problem is arisen even when this color printing is charged. The charging by the charging portion 105 is not limited to this example and may be executed when the image information to be provided is provided under conditions that exceed the predetermined conditions such as the number of pieces of information to be provided.

Like the A Store peripheral area guide 141, the selection of the image information to be provided may be executed using the characteristics of the place to which the digital multi-function peripheral 10 is installed as the image information to be provided.

Though the description has been given assuming the case where the image information to be provided is present as above, the case may be present where no image information is present as a result of the retrieving. Therefore, when no image information to be provided to be selected is present, the image information selecting portion 15 outputs the original image read by the image reading portion 13 using the image processing portion and the image output portion. In this manner, when the presence of the information that can be provided can not be confirmed, a process (any one of copying, transmission, and file-storing) based on the image of the image scanned is executed and, thereby, a process for the case where the original is an original that is desired to be ordinarily copied is enabled. Though the printing, etc., are not automatically executed, that no information that can be provided is present may be displayed and whether the original that has been read is printed may be confirmed as an image 150 of FIG. 8B. The printing is preferably executed only when the user has selected a YES key 151, and the process is preferably ended without executing anything when the user has selected the NO key 152.

The image information selecting portion 15 preferably has a presenting portion that presents to the user the information as to whether the image information to be provided to be selected is present, that is, the information on the presence or the absence of the information that can be provided. This presentation can be executed using the difference between the image 130 of FIG. 7A and the image 150 of FIG. 8B. However, the information on the presence or the absence may be displayed before displaying either of the images. Due to the guidance given by this presentation, the user does not wrongly recognize the system to have a fault even when no image information to be provided is present for the card, etc., that the user has brought and that has been read.

As above, an example where the license 121 of FIG. 6A is to be scanned has been shown. Instead, for example, when the license 121 of FIG. 6B is to be scanned, “ordinary motorbike” is not present for the type 123, “glasses, etc.” is described for the condition 124, and an image of glasses is present for the portion 126 of the face. Thereby, in the list of the overview information, the display of the contact lens store guide (because the user does not use contact lenses) and the latest motorbike (middle-sized) is blacked out as the image 130 of FIG. 7B.

When the license 121 of FIG. 6C is to be scanned, though “ordinary motorbike” is not present for the type 123 and “glasses, etc.” is described for the condition 124, no image of glasses is present for the portion 126 of the face. Thereby, in the list of the overview information, the display of the latest motorbike (middle-sized) is blacked out as the image 130 of FIG. 7B.

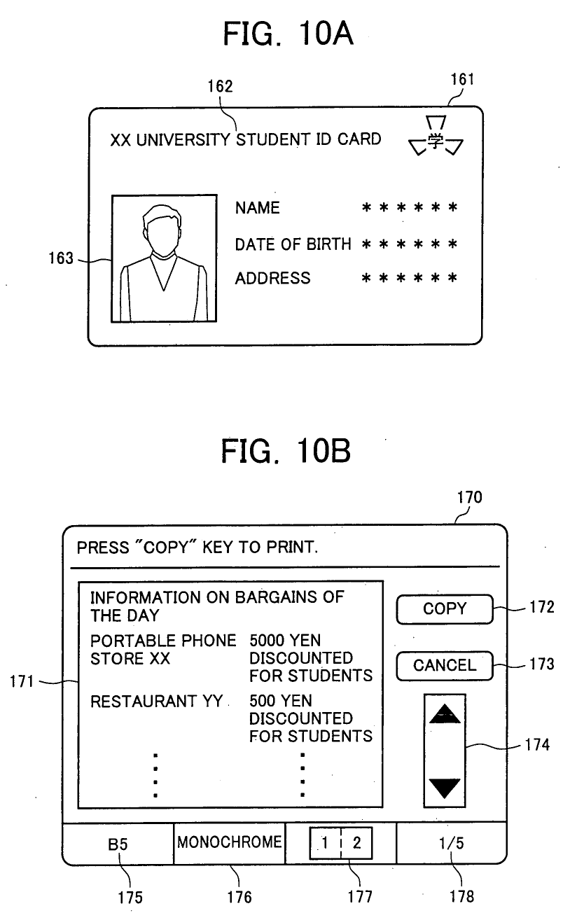

FIG. 10A is a diagram of an example of a student ID card to be scanned in the digital multi-function peripheral of FIG. 3. FIG. 10B is a diagram of an example of the image information to be provided displayed on the displaying portion when the student ID card of FIG. 10A is scanned. When the student ID card 161 of FIG. 10A is to be scanned, information 162 indicating that the item to be scanned is a student ID card, a face photograph includes glasses, etc., are preferably extracted as the image information.

Because it is known that the user is a student due to this extraction, information on bargains of the day may be selected in the peripheral area of the place to which the digital multi-function peripheral 10 is installed, and may be displayed on the displaying portion 102 as an image 170 of FIG. 10B. When only one piece of image information to be provided is present, the image information to be provided (information on bargains of the day 171) may be directly displayed without displaying the overview information list as above. Similarly to FIG. 8A, the image 170 displays a copying key 172, a cancellation key 173, a scrolling key 174 for the information on bargains of the day 171, a size 175 for printing (in this case, “B5” is set), a monochrome/color setting key 176 (in this case, “monochrome” is set), a key 177 for aggregated processing (in this case, “2-up” is set), and a key for the page number 178.

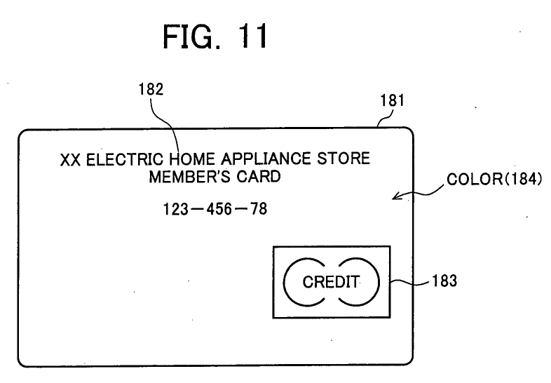

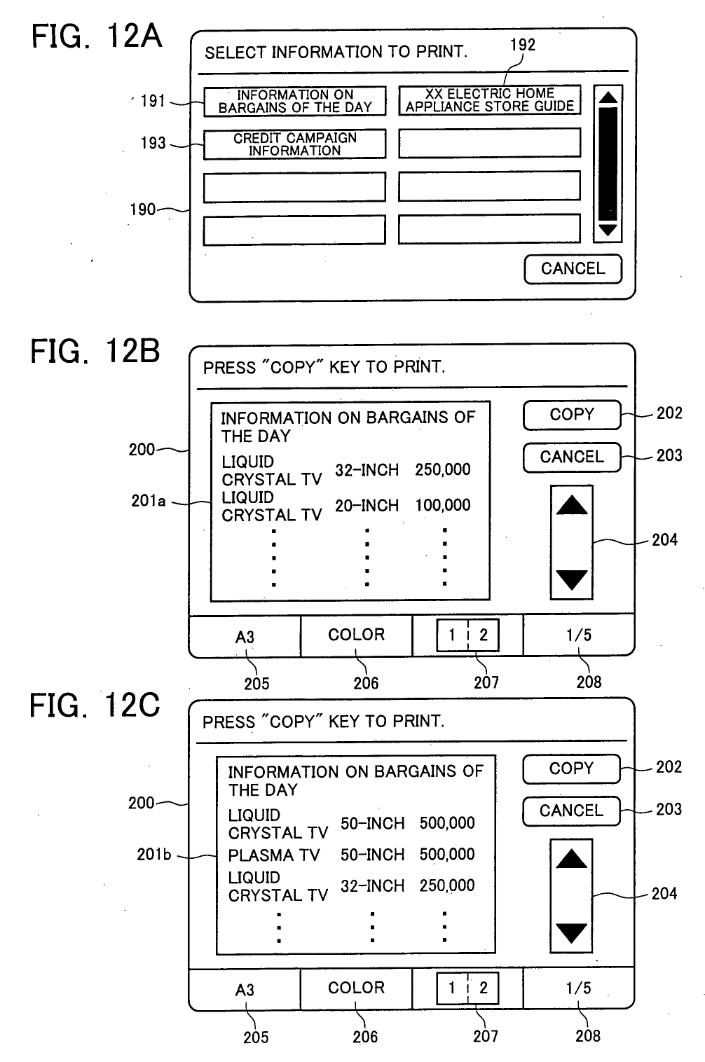

FIG. 11 is a diagram of an example of a credit card associated with an electric home appliance store to be scanned in the digital multi-function peripheral of FIG. 3. FIG. 12A is a diagram of an example of an overview information list displayed on the displaying portion when the credit card associated with the electric home appliance store of FIG. 11 is scanned. FIG. 12B is a diagram of an example of the image information to be provided displayed on the displaying portion when information on bargains of the day is selected by the user from the list of FIG. 12A. FIG. 12C is a diagram of another example for the FIG. 12B.

When the credit card 181 associated with an electric home appliance store exemplified in FIG. 11 is to be scanned, information 182 indicating that the item to be scanned is a card for XX electric home appliance store, the color of the card (184), information 183 indicating that the item to be scanned is a credit card, etc., are preferably extracted as the image information.

Due to this extraction, as a screen 190 exemplified in FIG. 12A, the information on bargains of the day 191 in the peripheral area of the place to which the digital multi-function peripheral 10 is installed, XX electric home appliance store guide 192, and credit campaign information 193 are selected, and the overview information list thereof is displayed on the displaying portion 102. When the user selects the information on bargains of the day 191 in this case, an image may be displayed as an image 200 of FIG. 12B.

However, in the case where the color (184) is extracted as the image information, when gold, platinum, or black is extracted, an item that is more expensive than an ordinary one is preferably displayed as the image information to be provided. Information on bargains 201b in an image 200 of FIG. 12C shows an example where an item is displayed that is more expensive than the item in the information on bargains 201a in the image 200 of FIG. 12B.

Similarly to FIG. 8A, the images 200 of FIGS. 12B and 12C each display a copying key 202, a cancellation key 203, a scrolling key 204 for the information on bargains of the day 201a/201b, a size 205 for printing (in this case, “A3” is set), a monochrome/color setting key 206 (in this case, “color” is set), a key 207 for aggregated processing (in this case, “2-up” is set), and a key for the page number 208.

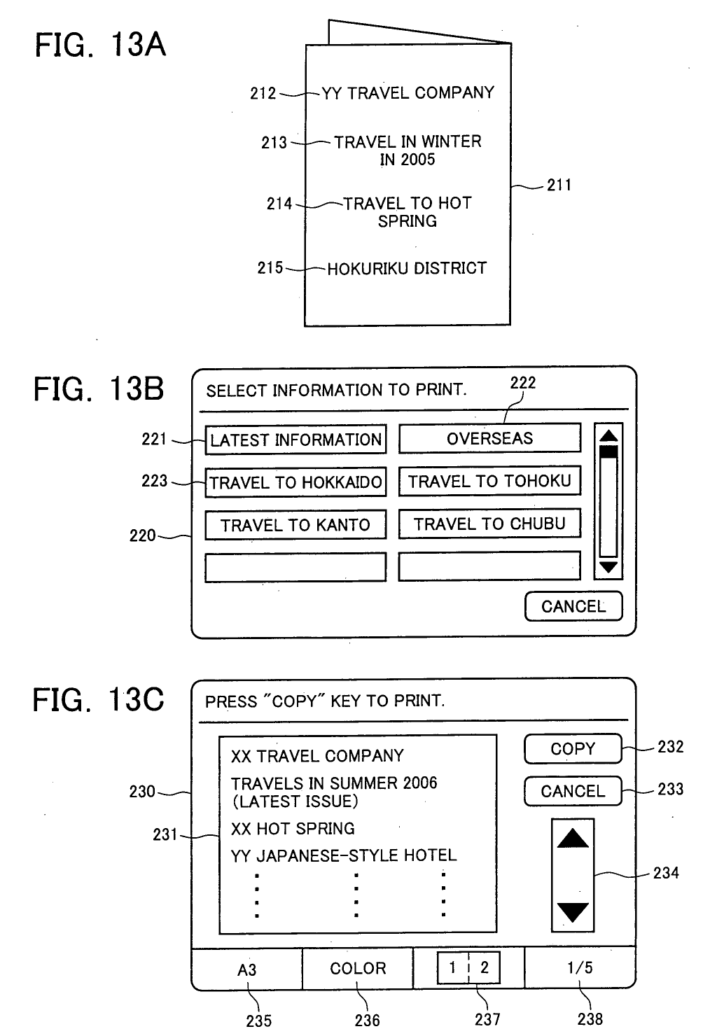

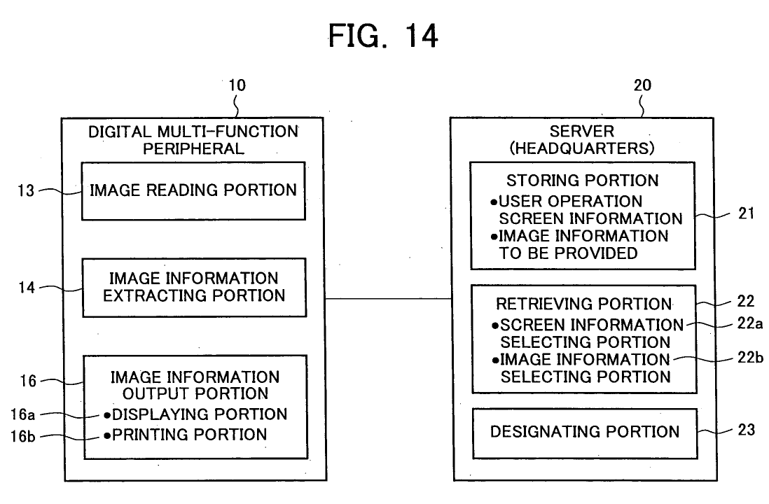

FIG. 13A is a diagram of an example of a travel pamphlet to be scanned in the digital multi-function peripheral of FIG. 3. FIG. 13B is a diagram of an example of an overview information list displayed on the displaying portion when the travel pamphlet of FIG. 13A is scanned. FIG. 13C is a diagram of an example of the image information to be provided displayed on the displaying portion when the latest information is selected by the user from the list of FIG. 13B.

When the travel pamphlet 211 exemplified in FIG. 13A is to be scanned, information 212 indicating that the item to be scanned is related to YY travel company, information 213 indicating that the item is related to winter in 2005, information 214 indicating that the item is related to a travel to a hot spring, information 215 indicating that the item is related to the Hokuriku region, etc., are preferably extracted as the image information.

Due to this extraction, as a screen 220 exemplified in FIG. 13B, pieces of information on a travel to a district other than the Hokuriku district such as “overseas” 222 and “Hokkaido” 223 in addition to the latest information 221 of the travel pamphlet 211 are selected and an overview information list thereof is displayed on the displaying portion 102. When the user selects the latest information 221 in this case, as an image 230 of FIG. 13C, if now it is spring in 2006, a latest pamphlet image 231 related to a travel to a hot spring in the Hokuriku district for summer in 2006 is preferably displayed considering the application of the travel. As above, using not only the characteristics of the place to which the digital multi-function peripheral 10 is installed but also the information on the date and the time to obtain the image information to be provided by the digital multi-function peripheral 10 as the image information to be provided, the selection of the image information to be provided may also be executed.

Similarly to FIG. 8A, the image 230 of FIG. 13C displays a copying key 232, a cancellation key 233, a scrolling key 234 for the latest information 231, a size 235 for printing (in this case, “A3” is set), a monochrome/color setting key 236 (in this case, “color” is set), a key 237 for aggregated processing (in this case, “2-up” is set), and a key for the page number 238.

Though color printing is set in this case, this may be set not only as the selection result of the user but also as an attribute of the image information to be provided that can only be color-printed. This attribute setting is effective for not only the travel pamphlet exemplified here but also a travel pamphlet that is not effective for advertising when images therein are not color images, etc., in addition to a pamphlet that has a photograph of fresh fish therein.

When a container of sweets, etc., are to be scanned, increase of the use frequency of the information provision service of the present embodiment can be expected by printing a photograph of a character as appendix information, printing a trading card for which the user does not know which card is printed, etc. When a magazine is to be scanned, it is preferable to print the latest issue thereof charging therefor.

As described above referring to FIGS. 1 to 13C, according to the present embodiment, providing image information such as advertisements and guides is enabled to people not limited to the specific user.

### Second Embodiment

Description will be given for an embodiment that can not only provide image information such as advertisements and guides to people not limited to the specific user but also easily provide information exactly in the form that the providing source of the image information desires. According to this embodiment, as described below, the server 20 has a portion corresponding to the above image information selecting portion 15.

An information providing system according to another embodiment of the present invention is a system to provide to a user image information (image information to be provided) such as advertisements and guides related to such items as cards, items, service catalogs, magazines, wrapping paper sheets (packaging boxes), etc. brought by the user by an image processing apparatus from those items. This information providing system is a system adapted to be connected by a network to a server apparatus that stores the image information to be provided and an image processing apparatus and to provide information using these apparatuses working together, and is further adapted to transmit user operating screen information from the server apparatus to the image processing apparatus and to cause the user to operate on the screen displaying this information. Thereby, the providing source of the image information to be provided can display the information exactly in the form that the providing source desires without being aware of the displaying form of the image processing apparatus. The image processing apparatus used in the present embodiment can be applied with various apparatuses such as a multi-function peripheral having various functions including a copying function and a printing function in addition to an image forming apparatus such as a copying machine and, hereinafter, those apparatuses are exemplified by a digital multi-function peripheral.

Similarly, in the present embodiment, an exemplary configuration described referring to FIG. 1 can be employed. FIG. 1 is a diagram of an exemplary configuration of a network system to provide the image information to be provided that a server apparatus (hereinafter, “server”) 20 retains to a digital multi-function peripheral 10 connected through a communication line.

The information providing service is operated by the headquarters 2 of chain stores 1 such as “A Store”, “B Store”, and “C Store”. For example, convenience stores can be listed as the chain stores 1. The server 20 is installed in the headquarters 2 to operate the information providing service. At least the digital multi-function peripheral 10 and also a PC (PC terminal) 11 are installed in each of the chain stores 1. The digital multi-function peripheral 10 preferably is connected to or incorporates a charging apparatus (not shown). The PC terminal 11 functions as a server in the chain stores 1, is connected to the digital multi-function peripheral 10, and is also connected to a POS terminal 12, etc. The server 20 is connected to the PC terminal 11 of each of the chain stores 1 through the Internet/intranet 31 or is directly connected to the digital multi-function peripheral 10.

For example, the server 20 is further connected to servers 40 and 50 respectively installed by providing sources 4 and 5 of the image information to be provided, through the Internet/intranet 32. As to these servers 40 and 50, the server 40 is connected to a network system configured by an in-house LAN as shown. This network system is connected to, for example, a plurality of PCs 41, a FAX 42, a digital multi-function peripheral 43, a printer 44, etc. The number of providing sources and the configuration of the network system installed thereto are not limited to the above. The providing sources 4 and 5 may directly transmit the image information to be provided to the headquarters 2 using a recording medium, etc. Otherwise, the headquarters 2 may create the image information to be provided in response to a request from the providing sources 4 and 5.

The providing sources 4 and 5 can easily create as described below user operation screen information for the digital multi-function peripheral 10 together with the image information to be provided and, therefore, can provide to the headquarters 2 the user operation screen information that displays an operation screen uniquely of the providing sources. The providing sources 4 and 5 can also request the headquarters 2 to create only the user operation screen information.

In the above exemplary configuration, the information provision according to the present embodiment is enabled by the network system of the in-house LAN and the digital multi-function peripheral 10 installed in each of the chain stores 1. When A Store, B Store, and C Store are not in the same chain, when those stores include store(s) that is(are) not in the same chain, or when those stores are installation places other than stores (such as stores in stations, or public facilities including libraries and government offices), the headquarters 2 corresponds to a manufacturer that sells the digital multi-function peripheral 10 or a sales company thereof, etc.

In the present embodiment, by providing the same functions for the servers 40 and 50, the providing sources 4 and 5 can directly transmit the image information to be provided and the user operation screen information to the digital multi-function peripheral 10 without passing through the server 20 of the headquarters 2.

FIG. 14 is a block diagram of other exemplary configurations of the digital multi-function peripheral and the server in the system of FIG. 1. To enable the information provision according to the present embodiment, the server 20 includes the storing portion 21 and the retrieving portion 22 described below. The server 20 may be that of distributed type configured by separating file servers, etc. On the other hand, the digital multi-function peripheral 10 includes the image reading portion 13, a displaying portion 16a, and the image information output portion 16 described below.

The storing portion 21 stores plural pieces of image information to be provided, and the user operation screen information for the digital multi-function peripheral 10. The image information to be provided is information to be selected by an image information selecting portion 22b described later. The user operation screen information is information to be selected by a screen information selecting portion 22a and is information to be displayed in an operation screen of the digital multi-function peripheral 10. These pieces of information may be updated through the network or by reading directly from a portable recording medium as necessary.

The server 20 transmits the user operation screen information using a communicating portion not shown in response to some request related to the information provision from the digital multi-function peripheral 10. The displaying portion 16a displays the user operation screen that the digital multi-function peripheral 10 itself has and the user operation screen transmitted from the server 20 as described below. However, because the displaying portion 16a can also function as a part of the image information output portion 16, this portion 16a is shown being included in the image information output portion 16.

The image reading portion 13 corresponds to a device such as a scanner that optically reads the image of an original, and is a portion that is ordinarily provided in the digital multi-function peripheral 10.

In this case, typical objects to be read (to be scanned) can be, for example, membership cards (rental, club), point cards, bank cards, credit cards, company-employee ID cards, student ID cards, insurance cards, licenses, item catalogs (electric home appliances, cars, etc.), service catalogs (substituting services, cleaning services, etc.), pamphlets (travels, etc.), cover pages and back cover pages of books (periodically sold magazines including weekly magazines, consecutively sold books including comic books), and outer cases of sweets and toys. As exemplified with a bank card and a credit card, a card medium such as a magnetic-recording-type card or an IC card that records and retains identifying information such as information on members, and from which the identifying information is read using a dedicated reader such as a card reader can be applied to a card. However, the information provision according to the present embodiment is executed by at least optically reading information on the front face or the back face of each of those card media.

The information providing system according to the present embodiment includes the image information extracting portion 14 that extracts image information from the image of the original read by the image reading portion 13, and the image information selecting portion 22b that selects the image information to be provided related to the image information extracted by the image information extracting portion 14 from the plurality of pieces of image information to be provided stored in advance in the storing portion 21. The image information extracted and the image information to be provided to be selected naturally differ from each other, and new image information (image information to be provided) is selected based on the image information.

The image information extracting portion 14 may be provided in either of the digital multi-function peripheral 10 or the server 20. In the former case, the extracted image information can be transmitted instead of the image of an original and, therefore, the communication load is small. Though the image information selecting portion 22b may be partially provided in the digital multi-function peripheral 10, the portion 22b is preferably provided in the server 20.

The image information extracting portion 14 preferably extracts the image information including any of extraction of text (text information), extraction of color (color information, color tone information), and extraction of image features. The extraction of image features means extraction of shape information having features (shape feature information) such as a logo. The text extraction may be executed by text retrieval after an OCR process.

The server 20 preferably has the following screen information selecting portion 22a. The screen information selecting portion 22a selects the user operation screen information to be transmitted to the digital multi-function peripheral 10 based on the image information extracted by the image information extracting portion 14 or based on the image information to be provided selected by the image information selecting portion 22b. In a form that does not include any screen information selecting portion 22a, a predetermined screen is transmitted and displayed, or no screen is transmitted and a screen prepared in advance in the digital multi-function peripheral 10 is used.

The retrieving portion 22 includes the above image information selecting portion 22b and the screen information selecting portion 22a, and returns the selection results of those portions. The server 20 preferably includes the following designating portion 23. The designating portion 23 designates the correlation between the image information and the image information to be provided in the image information selecting portion 22b, correlation between the image information and the user operation screen information, or the correlation between the image information to be provided and the user operation screen information. Though the designating portion 23 may not be provided, the correlations at least need to be executed in advance.

The digital multi-function peripheral 10 receives the user operation screen information transmitted from the server 20 and displays the received information on the displaying portion 16a. To display the user operation screen transmitted from the server 20, for example, a multi-purpose browser such as an XML browser may be incorporated in the displaying portion 16a. In this case, the user operation screen information transmitted from the server 20 is information created in the XML format and, when a touch panel is employed, the information is preferably operable on the touch panel. Any browser that is not the multi-purpose browser but a browser for which the manufacturer of the digital multi-function peripheral 10 has published the source may be used.

The digital multi-function peripheral 10 receives the user operation screen information transmitted from the server 20 and preferably displays the image information to be provided to be output by the image information output portion 16 being incorporated into the received user operation screen information using the displaying portion 16a. Thereby, the operation information of services that can be provided can be displayed on the operation panel, etc. based on the image data obtained by reading as the image of the original.

The image information output portion 16 may be referred to as “image information providing portion” and provides image information to the user by outputting the image information to be provided selected by the image information selecting portion 22b. In this case, the image information output portion 16 preferably outputs by executing one or more process (es) of a displaying process by the displaying portion 16a, a printing process by the printing portion 16b, and a file storing process or a file transmitting process to the image information selected by the image information selecting portion 22b.

In this case, examples of a combination of [item to be scanned: image information to be provided] can include [membership card: the latest information and campaign information], [point card: campaign information, item information, point information], [bank card: pamphlets of and application forms for services including a loan], [credit card: campaign information], [company employee ID card and student ID card: information on discount for employees], [insurance card, license: information on procedure guidance], [item catalog: the latest information and detailed information], [service catalog: the latest information and detailed information], [pamphlet: the latest information, detailed information, and additional information], [book: the latest issue], and [outer boxes of sweets and toys: information on giveaways and information on appendix (including the appendix itself)]. In addition, for all these items to be scanned, information on various items and services can be provided. However, many merits can be obtained when the information to be provided is suitable for the item to be scanned is selected. Therefore, the information to be provided is selected by the image information selecting portion 22b. As to the image information to be selected and provided, detailed examples will be given later.

As above, the image information to be provided preferably includes any one of advertisement information of items or services related to the image information, application information of items or services related to the image information, procedure guiding information related to the image information, the latest information related to the image information, detailed information related to the image information, and appendix information related to the image information.

The digital multi-function peripheral 10 as the image processing apparatus according to the embodiment preferably includes the image processing portion and the image output portion though those portions are normally equipped to the peripheral 10 and, in the following example, are listed as the printing portion. This image processing portion applies image processing to the image of the original itself that is read by the image reading portion 13. The image output portion outputs information on the image of the original processed by the image processing portion. The image information output portion 16 deals with objects to be output that are only different from those of the image output portion, and these portions can also be said to be portions that apply various types of image processing using the image processing portion and, thereafter, output the image information using the image output portion.

The server 20 can be configured by a computer (that is, a server computer) and a storing apparatus thereof corresponds to the storing portion 21. The retrieving portion 22 and the designating portion 23 are configured by being executably stored in a rewritable ROM, an HDD, etc., as a server program. The server program is read and brought into a volatile memory such as an incorporated RAM that is a working area, and is executed by a calculation processing apparatus such as a CPU incorporated in the server computer. The present invention can take not only the form of the server 20 but also the form of this server program. The image information extracting portion 14, etc., in the digital multi-function peripheral 10 are preferably incorporated as a program and the control portion of the digital multi-function peripheral 10 preferably is caused to function as those portions. This server program, and the control program for the digital multi-function peripheral 10 may be distributed through a network or being stored in a recording medium.

As described above, in the present embodiment, based on the image data obtained by reading not only a membership card brought by a user but also various items as an image of the original, image information to be provided to the user is selected and output. That is, in the present embodiment, when predetermined image information such as features of the original from the original image is confirmed by extraction, new image information to be provided can also be selected and output to be provided based on the extracted image information. When plural pieces of extracted image information are present, plural pieces of image information to be provided based respectively on those pieces of extracted image information can also be provided.

In the present embodiment, the image information that can be provided can be extracted based on the information on the image of the original read by the scanner, the operation screen information as a service to provide the extracted image information can be provided to the digital multi-function peripheral 10, and the image information to be provided requested thereafter on the operation screen from the digital multi-function peripheral 10 can be transmitted to the digital multi-function peripheral 10. Thereby, not only the screen for the user operation can be changed to a screen desired by the providing source of the image information to be provided and the providing source can easily create the screen, but also enhancement of the effect such as advertising is enabled.

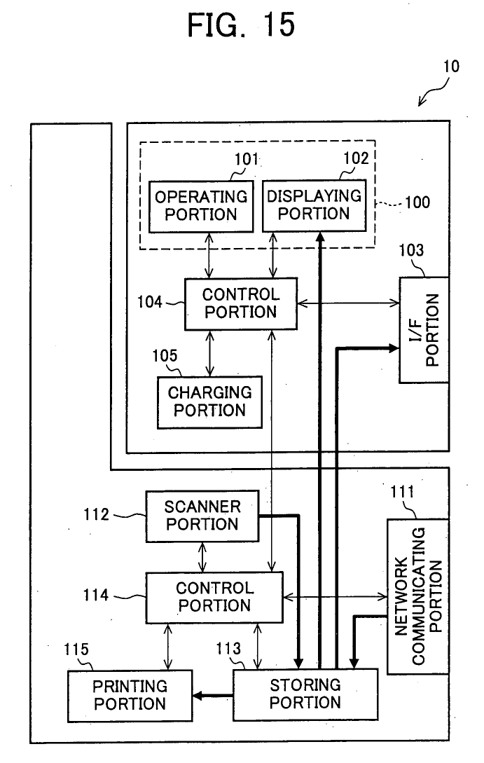

FIG. 15 is a block diagram for describing another exemplary internal configuration of the digital multi-function peripheral in the system of FIG. 1. The above FIG. 4 corresponds to a top plan view of the appearance of the scanner portion in the digital multi-function peripheral of FIG. 15. FIG. 5 corresponds to a diagram of an exemplary configuration of a user I/F portion in the digital multi-function peripheral of FIG. 15. Referring collectively to FIGS. 15, 4, and 5, description will be given for the digital multi-function peripheral 10 (and the server 20) of FIG. 14 taking a detailed example of the configuration.

The digital multi-function peripheral 10 includes the user I/F portion 100 configured by the operating portion 101 and the displaying portion 102. The operating portion 101 consists of a hard key group 101b such as ten keys and buttons to make various settings, a touch panel 101a, etc., and enables input operations by a user. The displaying portion 102 corresponds to the above displaying portion 16a and consists of a liquid crystal panel that displays various information screens, etc., and may be configured to be included by the above touch panel.

When the user operation screen information transmitted from the server 20 is displayed, a series of pieces of information may be stored in the storing portion 113 described later or a temporary memory, etc., or only one piece of information may be stored and an access may be made to the server 20 every time the screen is changed. The displaying portion 102 is also configured to output the image information to be provided to the user by a displaying process. Therefore, the displaying portion 102 can be caused to function as one of the above image information output portion and the image output portion, together with the control portions 104 and 114 that select the information to be output and instruct to display the information.

The digital multi-function peripheral 10 includes the I/F portion 103 to read and write data from/to a recording medium such as a USB memory. The I/F portion 103 is configured to output data such as image information to a recording medium to execute a file-storing process, and can be caused to function as one of the above image information output portion 16 and the image output portion, together with the control portions 104 and 114 that select the information to be output and instruct.

The charging portion 105 corresponds to the above charging apparatus and collects fees such as copying fees from the user and the fees of the image information to be provided, etc., provided in the present embodiment. The charging portion 105 is adapted to be able to execute any one of charging procedure of various procedures such as the settlement by a non-contact IC card, etc., and the settlement by putting in coins.

The control portion 104 controls the user I/F portion 100, the I/F portion 103, and the charging portion 105. The control portion 104 incorporates or is connected to, for example, a non-volatile memory such as a ROM that stores a control program, etc., to control these portions. The control program is read into a volatile memory such as an incorporated RAM that is a working area, and is executed by a calculation processing apparatus such as a CPU incorporated in the control portion 104. The control portion 104 controls the entire digital multi-function peripheral 10 together with the control portion 114 described later with either of the control portions 104 and 114 being the main control portion. Description will be given for a case where the control portion 114 is the main control portion and the control portion 104 is the sub control portion.

The network communicating portion 111 constitutes an I/F with a predetermined communication network such as a public line network or a LAN to enable an access to the server 20, etc. The data obtained from the communication network by the network communicating portion 111 is retained in a storing portion 113 or a temporary memory. The storing portion 113 is a storing apparatus such as an HDD or a rewritable ROM. The network communicating portion 111, and together with the storing portion 113 especially for the in-house use, together with the control portions 104 and 114 that select information to be output and issue instructions such as file transmission and file storage including mail transmission, can be caused to function as one of the above image information output portion 16 and the image output portion.

As exemplified in FIG. 4, the scanner portion 112 obtains original image (original image data) by reading the image of the original for the original such as a card C that the user has mounted on the original glass 112a and causes the storing portion 113 or the temporary memory to store the image. In this case, the start of the scanning, etc., is executed by the user I/F portion 100. As exemplified in FIG. 5, the touch panel 101a is incorporated with a graphical user I/F (GUI) to enable an operation to execute “ordinary copying” and an operation to request provision of the image information to be provided by executing “reading an original such as a card”. By causing the GUI to display the image only for the latter, the operation only for copying may be simplified. The user operation screen information can be received and displayed as GUI.

The printing portion 115 reads the original image data that the scanner portion 112 has read, printing data externally input through the network communicating portion 111, etc., from the storing portion 113 or the temporary memory, and outputs those data by printing-processing on sheets such as paper sheets. The printing portion 115 can be caused to function as one of the above image information output portion 16 and the image output portion, together with the control portions 104 and 114 that select the data to be output and instruct to print the data.

The control portion 114 controls the network communicating portion 111, the scanner portion 112, the storing portion 113, the printing portion 115, and the control portion 104. The control portion 114 incorporates or is connected to, for example, a non-volatile memory such as a ROM that stores a control program, etc., to control these portions. The control program is read into a volatile memory such as an incorporated RAM that is a working area, and is executed by a calculation processing apparatus such as a CPU incorporated in the control portion 114. The control program incorporated in the control portion 114 is a program to cause the control portion 114 (an internal calculation processing apparatus) of the digital multi-function peripheral 10 to function as the image information extracting portion 14, etc., as above.

By executing this program, the control portion 114 controls such that the image information is extracted from the original image read by the scanner portion 112, the server 20 is accessed, the user operation screen information is received and is displayed on the displaying portion 102, and the image information to be provided selected related to the image information is received and is output by the printing portion 115, etc. The information for extraction (information indicating what information is to be extracted or information for pattern matching, etc.) may be stored in the storing portion 113 or the ROM, or be included in the program as a parameter.

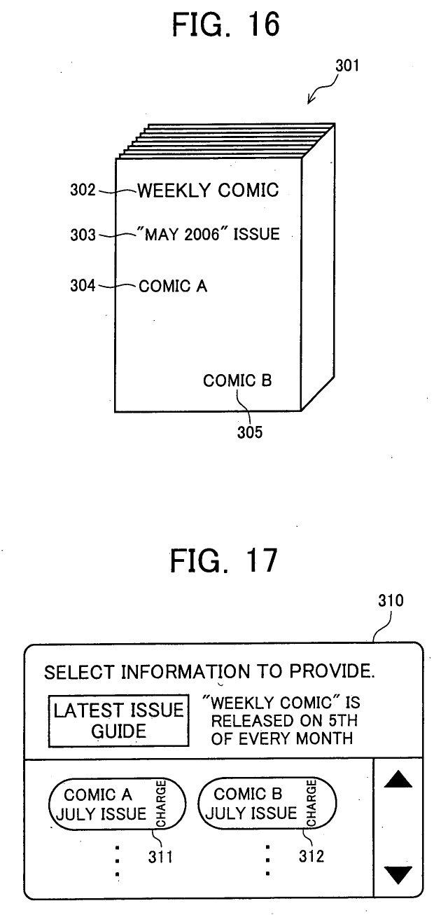

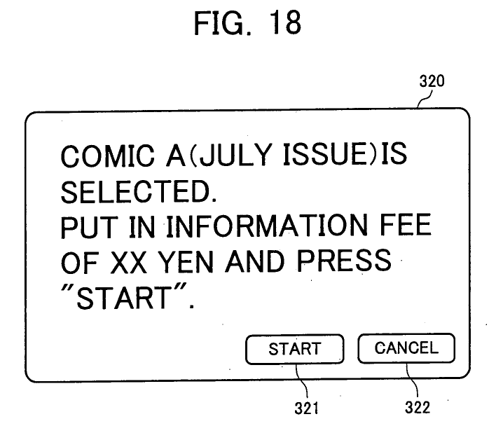

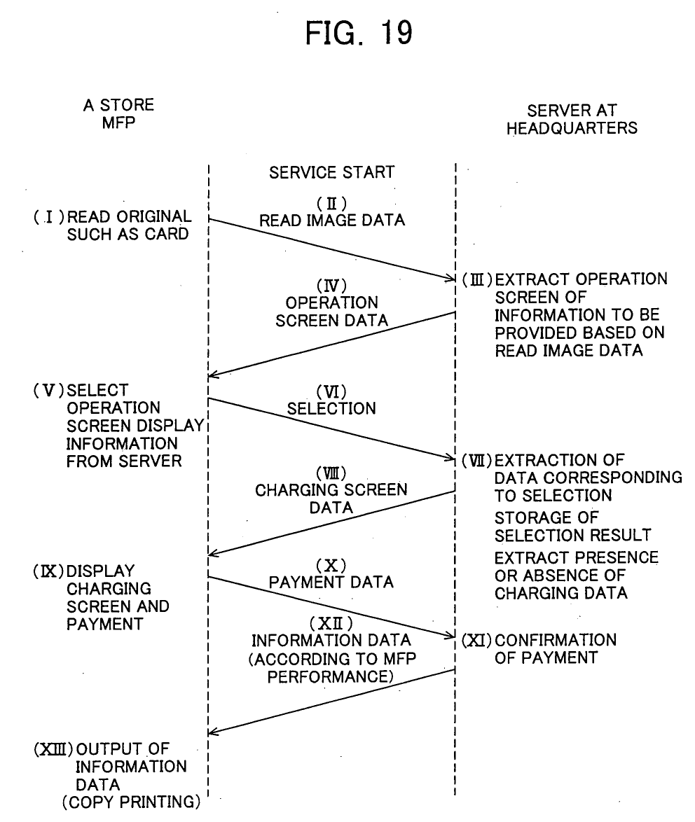

FIG. 16 is a diagram of an example of a magazine to be scanned in the digital multi-function peripheral of FIG. 15. FIG. 17 is a diagram of an example of an overview information list displayed on the displaying portion when the magazine of FIG. 16 is scanned. FIG. 18 is a diagram of an example of charging information displayed on the displaying portion when a comic book “A” is selected by the user from the overview information list of FIG. 17. FIG. 19 is a flowchart for describing exemplary processing shown in FIGS. 16 to 18.

Description will be given along the flow exemplified in FIG. 19. However, in the following description, the flow is not limited as follows, including, for example, that the extracted image information is transmitted to the server 20 when the digital multi-function peripheral 10 executes processes to the extraction of the image information.

A user selects “reading original such as a card” in the touch panel 101a of FIG. 5 and the control portion 114 recognizes this selection. When a magazine 301 exemplified in FIG. 16 is mounted on the original glass 112a as the card C of FIG. 4 and is scanned by the scanner portion 112 (I), the read image data is transmitted to the control portion 114 (II). The control portion 114 controls to cause the network communicating portion 111 to access the server 20 through the intranet 31, and transmits the image data to the server 20. Concurrently with the above II, the control portion 114 requests the user operation screen information as the start of the service. At the time when “reading the original such as a card” is pressed down for the user to receive the information providing service (even before the scanning), or at the time when the included hard key is pressed down, the server 20 may be accessed and the user operation screen information may be requested.

In the server 20, the retrieving portion 22 extracts the image information from the image data and the screen information selecting portion 22a extracts and selects the user operation screen information stored in the storing portion 21 based on the extracted image information (III). At this point, the selection of the user operation screen information from the image data may be executed without extracting the image information. In the example of FIG. 14, the description has been given including that the server 20 does not execute the extraction of the image information. However, the extraction is executed by the retrieving portion 22 in this case. The typical image information can be title information 302 (for example, the largest text) showing that the item is a weekly comic magazine, date information 303 showing which month this magazine is issued for, comic title information 304 and 305 (for example, a rather small text that can not be assumed to be the author's name) showing what comics are included, etc. For example, a screen 310 exemplified in FIG. 17 is selected as the user operation screen information. Otherwise, only the frame of the screen 310 is selected as the user operation screen information as described below and the contents thereof is selected as the image information to be provided.

The server 20 transmits to the digital multi-function peripheral 10 the user operation screen information (operation screen data) selected at above III (IV). In the digital multi-function peripheral 10, the control portion 114 receives the operation screen data through the network communicating portion 111 and controls to cause the control portion 104 to display the data in the operation screen (the touch panel 101a) of the displaying portion 102. As a result, the screen 310 of FIG. 17 is displayed on the touch panel 101a (V). The screen 310 displays a list of a comic “A” 311, a comic “B” 312, etc., that are included in the weekly comic magazine 301. The comic A 311, the comic B 312, etc., are displayed being selectable by the user. When those comics are extracted as comics and, however, are not released, those comics may be displayed being blacked out and may not be selectable by the user.

When the user selects, for example, a July issue of the comic A in the screen 310 using the operating portion 101, the information is transmitted to the control portion 114 through the control portion 104 and the control portion 114 transmits the selection data (request data of obtaining the July issue of the comic A) to the server 20 through the network communicating portion 111 to notify the server 20 of the data (VI). In the server 20, the image information selecting portion 22b selects the image information to be provided (in this case, July issue of the comic A) according to this selection (VII).

At the above VII, concurrently with this selection or confirmation of the payment described later, the selection result may be stored in the storing portion 21 for totaling. In this manner, the server 20 preferably has a totaling portion that totals the image information to be provided that has been selected by the image information selecting portion 22b and output by the image information output portion 16. By totaling the image information to be provided that has been actually provided, not only the statistics representing how far the advertising activity can be executed can be obtained but also charging of the consideration to the place to provide the image information to be provided can be executed and the number of copies sold, etc., can be grasped when the image information to be provided is a magazine, etc.

Furthermore, the presence or absence of charging is preferably extracted at the above VII. To do this, the image information selecting portion 22b preferably has a charging information presenting portion that presents to the user the information on the charging to the image information to be provided to be selected. To present to the user, the server 20 transmits the charging information (charging screen data) as one piece of the user operation screen information to the digital multi-function peripheral 10. This charging information includes an image that carries whether or not the charging is approved (a start key 321/a cancellation key 322) together with the amount of money as a screen 320 exemplified in FIG. 18, and this image is displayed being incorporated into the user operation screen information on the displaying portion 16a (IX). The charging information is also transmitted to the charging portion 105. The user pays the money using the charging portion 105 and, at the time when the user has pressed down the start key 321, payment data (payment completion data) is transmitted to the server 20 (X). The server 20 confirms the payment by receiving the payment data (XI).

As above, the charging information of the information that can be provided is preferably transmitted additionally and the digital multi-function peripheral 10 preferably executes the settlement process based on the charging information when the image information is output. For the comics, all of them are often sold being charged. However, when color printing is set based on the monochrome printing, the information may be charged and the charging information thereof is notified of to the digital multi-function peripheral 10. Then, the charging portion 105 may charge. When a map is printed as the image information to be provided, etc., the map is preferably color-printed and the user also strongly desires the color-printing. Therefore, charging in this case arises no problem. The charging by the charging portion 105 may also be executed according to an instruction from the server 20 when the server 20 provides the image information to be provided exceeding the predetermined conditions such as the number of pieces of information to be provided, not limited to this case.

To enable the selection of color/monochrome printing, the digital multi-function peripheral 10 preferably includes a setting portion that causes the user to set the printing conditions such as the size for the printing, monochrome/color setting, aggregated processing (n in one or N-up), etc. Thereby, printing under the output conditions designated by the user is enabled. This setting portion may be provided from the server 20 as one piece of the user operation screen information.

Following the above XI, the server 20 transmits to the digital multi-function peripheral 10 the image information to be provided selected at the above VII (in this case, the July issue of the comic A) (XII). At this step, the image information to be provided may be transmitted with a differed resolution according to the performance of the digital multi-function peripheral 10. In the digital multi-function peripheral 10, the control portion 114 instructs the printing portion 115 to print the image information to be provided received from the server 20 and stored in the storing portion 113 or the temporary memory and the printing portion 115 prints the information. Then, the user obtains the printed July issue of the comic A (XIII).

The image information selecting portion 22b preferably has a presenting portion that presents to the user the information as to whether the selected image information to be provided is present, that is, the information on the presence or the absence of the information that can be provided. Although it is not shown, the presence or the absence may be displayed being incorporated in the user operation screen information by the displaying portion 16a. Due to the guidance given by this presentation, the user does not wrongly recognize the system to have a fault even when no image information to be provided is present for the card, etc., that the user has brought and that has been read.

In the form where only the frame of the screen 310 is selected and transmitted as the user operation screen information in the above IV, the digital multi-function peripheral 10 may again access the server 20, obtain the information of the list, and display the list. In this form, an information selecting portion that selects plural pieces of information and an overview presenting portion that presents the overview information, etc., that will be described as below can realize those processes.

The image information selecting portion 22b is preferably provided with an information selecting portion that selects plural pieces of image information to be provided related to the image information extracted by the image information extracting portion 14 and an overview presenting portion that presents to the user the overview information related to the plural pieces of image information to be provided selected by the information selecting portion. That is, the image information to be provided once selected by the image information selecting portion 22b is preferably shown to the user and transmission is preferably shown about the image information to be provided that is desired to be output and provided of the shown information. Similarly to the screen 310 of FIG. 17, the overview information is displayed being incorporated in the user operation screen information by the displaying portion 16a. Typical overview information can be information excerpted from the image information to be provided or a summary (thumbnail) of the image information. The image information selecting portion 22b includes an overview selecting portion that causes the user to select the overview information of the image information to be provided that the user desires to output from a plurality of pieces of overview information presented by the overview presenting portion, and may select the image information to be provided related to the overview information selected by the overview selecting portion as the item to be output by the image information output portion 16.

In this form provided with the information selecting portion that selects plural pieces of image information and the overview presenting portion that presents to the user the overview information, usefulness is ensured when hierarchically selecting image information to be provided.

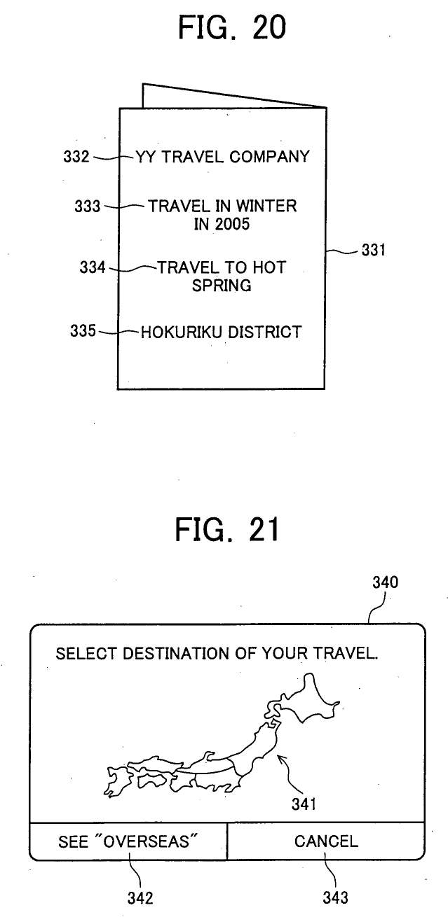

FIG. 20 is a diagram of an example of a travel pamphlet to be scanned in the digital multi-function peripheral of FIG. 15. FIG. 21 is a diagram of an example of an overview information list displayed on the displaying portion when the travel pamphlet of FIG. 20 is scanned.

When a travel pamphlet 331 exemplified in FIG. 20 is to be scanned, information 332 indicating that the company is YY travel company, information 333 indicating that the season is winter in 2005, information 334 indicating that the type is a travel to a hot spring, information 335 indicating that the region is Hokuriku region, etc., are preferably extracted as image information.

Due to this extraction, user operation screen information as a screen 340 exemplified in FIG. 21 can be selected by the screen information selecting portion 22a. The screen 340 displays 342 that displays overseas information and cancellation key 343 being selectable by the user, together with a map of Japan 341. The map of Japan 341 is divided into regions and each region is displayed being selectable by the user.

When the user selects a destination that the user desires, the server 20 transmits a travel pamphlet of the destination. For example, when it is spring in 2006, a latest pamphlet image, etc., for summer in 2006 considering the application of the travel and related to the destination is transmitted. As above, using not only the characteristics of the place to which the digital multi-function peripheral 10 is installed but also the information on the date and the time to obtain the image information to be provided by the digital multi-function peripheral 10 as the image information to be provided, the selection of the image information to be provided may also be executed. The digital multi-function peripheral 10 can provide to the user the latest pamphlet that the user desires by displaying or displaying and printing the image.

For a travel pamphlet, the degree of the user's desire of purchase differs depending on how beautiful the pamphlet shows the scenery, etc. Therefore, an item such as a travel pamphlet is preferably color-printed forcibly in spite of the user settings for the above printing conditions. For example, the server 20 may also set as an attribute of the image information to be provided such that only color printing is executed. Attribute settings to secure the above output form (addition of securing information) are effective for not only the travel pamphlets exemplified herein but also those that only exert low advertising effects without color images including the one that carries a photograph of fresh fish. A condition that the color-printing is enabled only when the consideration is paid may be added as the securing information. In this manner, the image information to be provided selected by the image information selecting portion 22b is preferably added with the securing information that secures the output form thereof. The securing information is preferably managed by the server 20 and the manager can preferably designate what output form is employed for each image information to be provided.

Furthermore, for example, when a license is to be scanned as described referring to FIG. 6, typical image information can be a photograph of a face for extracting the features thereof, an expiration date for extraction of a text, type, and conditions. Typical image information to be provided can be selected as a peripheral area driving guide, a license center guide, a latest car (2,000-cc class), a latest motorbike (50 cc), a latest car (light-weighted), a latest motorbike (middle-sized).

Only when it is close to the expiration date according to the date of obtaining the image information to be provided, the license center guide may be selected. The selection of the image information to be provided may be executed using the characteristics of the place to which the digital multi-function peripheral 10 is installed as the image information to be provided such that the characteristics of the place is necessary when the peripheral area driving guide is selected. When no display of “glasses, etc.” is present in the conditions as the image information and no “glasses” are present in the face portion of the photograph as the image information, the extraction is preferably executed using the conditions or the face portion as the image information such that the overview information such as a glasses store guide or a contact lens store guide is not retrieved. In this manner, the image information extracting portion 14 may cut out a portion of the original image (the photograph 125 of FIGS. 6A to 6C) read by the image reading portion 13 and may extract the image information from the cut-out partial image.

When a student ID card is to be scanned, information indicating that the item is a student ID card, information indicating whether the face photograph includes glasses, etc., are preferably extracted as the image information, and information on bargains of items related to students, etc., are preferably selected based on the periphery of the place to which the digital multi-function peripheral 10 is installed and are preferably the information to be output.

When a credit card associated with an electric home appliance store, etc., is to be scanned, information indicating that the item is a card for XX electric home appliance store, the color of the card, information indicating that the item is a credit card, etc., are preferably extracted as the image information. Due to this extraction, information on bargains of the day and electric home appliance store guide of the peripheral area of the place to which the peripheral 10 is installed, or credit campaign information, etc., are selected and output thereof is enabled. In the case where the color is extracted as the image information, when gold, platinum, or black is extracted, items that are more expensive than the ordinary items may be displayed as the image information to be provided.

When a container of sweets, etc., are to be scanned, increase of the use frequency of the information providing service of the present embodiment can be expected by printing a photograph of a character as appendix information, printing a trading card such that the user does not know which card is printed, etc.

As described referring to FIGS. 1, 4, 5, 6A to 6C, and 14 to 21, according to the present embodiment, providing image information such as an advertisement or a guide to people not limited to the specific users is enabled and information can easily be provided exactly in the form that the provider of the image information desires.

1. An image processing apparatus comprising:
an image reading portion that optically reads an image of an original;
an image information extracting portion that extracts image information from the image of the original read by the image reading portion;
an image information selecting portion that selects image information to be provided related to the image information extracted by the image information extracting portion from a plurality of pieces of image information to be provided prepared in advance; and
an image information output portion that outputs the image information to be provided selected by the image information selecting portion.

2. The image processing apparatus as defined in claim 1, wherein
the image information to be provided includes any of advertisement information of an item or a service related to the image information, application information of an item or a service related to the image information, procedure guiding information related to the image information, the latest information related to the image information, detailed information related to the image information, and appendix information related to the image information.

3. The image processing apparatus as defined in claim 1, wherein
the image information extracting portion executes extraction including any of extraction of a text, extraction of a color, and extraction of image features as the extraction of the image information.

4. The image processing apparatus as defined in claim 1, wherein
the image information extracting portion cuts out a portion of the image of the original read by the image reading portion and executes extraction of image information from the cut-out partial image.

5. The image processing apparatus as defined in claim 1, wherein
the image information selecting portion comprises:
an information selecting portion that selects a plurality of pieces of image information to be provided related to the image information extracted by the image information extracting portion;
an overview presenting portion that presents to a user overview information related to the selected plurality of pieces of image information to be provided; and
an overview selecting portion that causes the user to select overview information of image information to be provided that the user desires to output from the presented plurality of pieces of overview information, wherein
the image information selecting portion selects image information to be provided related to the selected overview information as information to be output by the image information output portion.

6. The image processing apparatus as defined in claim 1, further comprising:
an image processing portion that applies image processing to the image of the original read by the image reading portion; and
an image output portion that outputs the information on the image of the original processed by the image processing portion.

7. The image processing apparatus as defined in claim 6, wherein
the image information selecting portion outputs the image of the original read by the image reading portion using the image processing portion and the image output portion when image information to be provided to be selected is not present.

8. The image processing apparatus as defined in claim 1, wherein
the image information selecting portion comprises a presenting portion that presents to the user whether image information to be provided to be selected is present.

9. The image processing apparatus as defined in claim 1, wherein
the image information output portion outputs the image information selected by the image information selecting portion by any process of a printing process, a displaying process, a file-storing process, and a file-transmission process.

10. The image processing apparatus as defined in claim 1, wherein
the image information output portion comprises:
a printing portion that outputs by a printing process the image information selected by the image information selecting portion; and
a setting portion that causes a user to set printing conditions for printing by the printing portion.

11. The image processing apparatus as defined in claim 1, wherein
the image processing apparatus is a multi-function peripheral having at least a printing function and a copying function.

12. The image processing apparatus as defined in claim 1, further comprising
a designating portion that designates the correlation between the image information and the image information to be provided in the image information selecting portion.

13. The image processing apparatus as defined in claim 1, further comprising
a storing portion that stores a plurality of pieces of image information to be provided to be selected by the image information selecting portion.

14. An information providing system comprising the image processing apparatus as defined in claim 1 and a server apparatus, wherein
the server apparatus comprises:
a storing portion that stores the plurality of pieces of image information to be provided to be selected by the image information selecting portion; and
a retrieving portion that returns a selection result based on a selection request from the image information selecting portion.

15. The information providing system as defined in claim 14, wherein
the server apparatus comprises
a designating portion that designates the correlation between the image information and the image information to be provided in the image information selecting portion.

16. A server apparatus that can be connected to an image processing apparatus comprising an image reading portion that optically reads an image of an original, comprising:
an image information extracting portion that receives an image of an original read by the image reading portion and extracts image information from the image of the original; and
an image information selecting portion that selects image information to be provided related to the image information extracted by the image information extracting portion from plural pieces of image information to be provided prepared in advance and that transmits the selected information to the image processing apparatus, wherein
the image processing apparatus comprises an image information output portion that outputs the image information to be provided selected by the image information selecting portion.

17. A program incorporated into the image processing apparatus as defined in claim 1, wherein
a control portion of the image processing apparatus is caused to function as the image information extracting portion and the image information selecting portion.

18. A program incorporated into the server apparatus in the information providing system as defined in claim 14, wherein
a computer is caused to function as the server apparatus.

19. A program incorporated into the server apparatus as defined in claim 16, wherein
a computer is caused to function as the server apparatus.

20. An information providing system that provides image information to be provided to a user using an image processing apparatus, comprising:
the image processing apparatus comprising:
an image reading portion that optically reads an image of an original; and
a displaying portion that displays a user operation screen; and
a server apparatus connected to the image processing apparatus through a network, comprising:
a storing portion that stores a plurality of pieces of image information to be provided and user operation screen information for the image processing apparatus, wherein
the system further comprises:
an image information extracting portion that extracts image information from the image of the original read by the image reading portion; and
an image information selecting portion that selects image information to be provided related to the image information extracted by the image information extracting portion from the plurality of pieces of image information to be provided stored in advance by the storing portion, wherein
the image processing apparatus comprises an image information output portion that outputs the image information to be provided selected by the image information selecting portion, and wherein
the image processing apparatus receives the user operation screen information transmitted from the server apparatus and displays the received information using the displaying portion.

21. The information providing system as defined in claim 20, wherein
the image processing apparatus receives the user operation screen information transmitted from the server apparatus and displays the image information to be provided incorporating into the received user operation screen information using the displaying portion.

22. The information providing system as defined in claim 20, wherein
the server apparatus selects the user operation screen information to be transmitted to the image processing apparatus based on the image information extracted by the image information extracting portion or based on the image information to be provided selected by the image information selecting portion.

23. The information providing system as defined in claim 20, wherein
the image information selecting portion is provided in the server apparatus.

24. The information providing system as defined in claim 20, wherein
the image information extracting portion is provided in the image processing apparatus.

25. The information providing system as defined in claim 20, wherein
the image information extracting portion is provided in the server apparatus.

26. The information providing system as defined in claim 20, wherein
the image information selecting portion comprises:
an information selecting portion that selects a plurality of pieces of image information to be provided related to the image information extracted by the image information extracting portion;
an overview presenting portion that presents to a user overview information related to the selected plurality of pieces of image information to be provided; and
an overview selecting portion that causes the user to select overview information of image information to be provided that the user desires to output from the presented plurality of pieces of overview information, wherein
the image information selecting portion selects image information to be provided related to the selected overview information as information to be output by the image information output portion, and wherein
the overview information is displayed being incorporated into the user operation screen information by the displaying portion.

27. The information providing system as defined in claim 20, wherein
the image information selecting portion comprises a presenting portion that presents to the user whether image information to be provided to be selected is present, wherein
the presence or absence is displayed being incorporated into the user operation screen information by the displaying portion.

28. The information providing system as defined in claim 20, wherein
the image information selecting portion comprises a charging information presenting portion that presents to a user charging information for the image information to be provided to be selected, wherein
the charging information is displayed being incorporated into the user operation screen information by the displaying portion.

29. The information providing system as defined in claim 20, wherein
the image information to be provided to be selected by the image information selecting portion is added with securing information that secures the output form thereof.

30. The information providing system as defined in claim 20, wherein
the server apparatus comprises a totaling portion that totals the image information to be provided selected by the image information selecting portion and output by the image information output portion.

31. The information providing system as defined in claim 20, wherein
the image information to be provided includes any of advertisement information of an item or a service related to the image information, application information of an item or a service related to the image information, procedure guiding information related to the image information, the latest information related to the image information, detailed information related to the image information, and appendix information related to the image information.

32. The information providing system as defined in claim 20, wherein
the image information extracting portion executes extraction including any of extraction of a text, extraction of a color, and extraction of image features as the extraction of the image information.

33. The information providing system as defined in claim 20, wherein
the image processing apparatus is a multi-function peripheral having at least a printing function and a copying function.

34. A server apparatus in the information providing system as defined in claim 20.

35. A program incorporated into the server apparatus in the information providing system as defined in claim 20, wherein
the program causes a computer to function as the server apparatus.
